(19) United States
(12) Patent Application Publication
(10) Pub. No.: US 2025/0352904 A1
(43) Pub. Date: Nov. 20, 2025

(54) COMPUTER-READABLE NON-TRANSITORY STORAGE MEDIUM HAVING GAME PROGRAM STORED THEREIN, GAME PROCESSING METHOD, GAME SYSTEM, AND GAME APPARATUS

(71) Applicant: NINTENDO CO., LTD., Kyoto (JP)

(72) Inventors: Yuto HASEGAWA, Tokyo (JP); Shinya KUBOTA, Tokyo (JP)

(21) Appl. No.: 19/175,978

(22) Filed: Apr. 10, 2025

(30) Foreign Application Priority Data
May 15, 2024 (JP) 2024-079639

(51) Int. Cl. A63F 13/573; A63F 13/211; A63F 13/22; A63F 13/812

(52) U.S. Cl. CPC A63F 13/573; A63F 13/211; A63F 13/22; A63F 13/812

(57) ABSTRACT

In a ball sport game, based on operation data including at least acceleration data and angular velocity data, the following is executed: setting and updating a correspondence relationship between a direction in a space and a direction with respect to an operation device, in accordance with an orientation around a predetermined axis of the operation device; identifying an orientation of the operation device regarding a pitch in the space; in a case where a first condition for at least one of the acceleration data and the angular velocity data in an up-down direction in the space is satisfied, moving a player character having a ball; and in a case where a second condition for an orientation regarding the pitch in the space and at least one of the acceleration data and the angular velocity data is satisfied, causing the player character to do a shot action of shooting the ball.

### CROSS REFERENCE TO RELATED APPLICATION

This application claims priority to Japanese Patent Application No. 2024-079639 filed on May 15, 2024, the entire contents of which are incorporated herein by reference.

### FIELD

The present disclosure relates to ball sport game processing for playing by moving an operation device itself.

### BACKGROUND AND SUMMARY

Conventionally, there has been known a ball sport game in which a ball can be shot by an operation of swinging an operation device (hereinafter, controller).

In the above game, for example, a user can shoot a ball by an operation of swinging the right hand grasping a controller having a substantially bar-like shape.

In this regard, in a case where the controller which can be grasped by one hand has, for example, a flat-plate shape, the way of holding the controller, i.e., which face of the controller is directed upward when a user holds and operates the controller, can differ among users. In addition, depending on development in the game, the way of holding the controller (the orientation of the controller) might change during play. Therefore, for example, in a case of performing control based on the direction in which the controller is swung and the orientation of the controller at this time, differences in the way of holding the controller have some influence that might lead to a situation in which a result of an operation intended by a user is not obtained.

Configuration examples according to the present disclosure will be shown below.

### Configuration 1

A configuration 1 is a game program configured to cause a computer of an information processing apparatus to execute a ball sport game. In the ball sport game, based on operation data including at least acceleration data and angular velocity data and transmitted from an operation device including an acceleration sensor and an angular velocity sensor, the computer executes: setting and updating a correspondence relationship between a direction in a space and a direction with respect to the operation device, in accordance with an orientation around a predetermined axis of the operation device; identifying an orientation of the operation device regarding a pitch in the space; in a case where a first condition for at least one of the acceleration data and the angular velocity data in at least an up-down direction in the space is satisfied, causing a player character having a ball to do an action of moving on a field in a game space; and in a case where a second condition for an orientation regarding the pitch in the space and at least one of the acceleration data and the angular velocity data is satisfied, causing the player character having the ball to do a shot action of shooting the ball.

According to the above configuration, it is possible to perform an operation of moving the operation device while being hardly influenced by the way of holding with respect to the predetermined axis.

### Configuration 2

In a configuration 2 based on the above configuration 1, the operation device may have a shape elongated in a longitudinal direction, the predetermined axis is an axis along the longitudinal direction of the operation device, and the orientation regarding the pitch in the space may be a pitch of a direction vector of the predetermined axis in the space.

According to the above configuration, when causing the player character to do a predetermined action, it is possible to cause the player character to do the predetermined action by moving the operation device while being hardly influenced by a difference in the orientation of the controller due to a difference in the way of holding the operation device.

### Configuration 3

In a configuration 3 based on the above configuration 2, the operation device may have a button surface at which an operation button is provided. Based on the operation data, the computer may further execute: identifying at least in which state the button surface is among an upward state, a rightward state, and a leftward state, and setting and updating the correspondence relationship between the direction in the space and the direction of the operation device, based on the identified state.

According to the above configuration, for example, if the operation device is held with the thumb always contacting with the button surface, it is possible to cause the player character to do a predetermined action by a similar way of moving the arm, irrespective of the orientation of the operation device.

### Configuration 4

In a configuration 4 based on the above configuration 2, the computer may further execute: in a case where the pitch of the direction vector of the predetermined axis in the space is in an upward first range, refraining from updating the correspondence relationship between the direction in the space and the direction of the operation device in accordance with the orientation around the predetermined axis of the operation device.

According to the above configuration, in a case where the operation device has an upward orientation, it is possible to inhibit the correspondence relationship of the directions from unintentionally changing.

### Configuration 5

In a configuration 5 based on any one of the above configurations 1 to 4, the first condition may include at least that a magnitude of an acceleration applied in the up-down direction in the space exceeds a first threshold.

According to the above configuration, it is possible to move the player character, using, as a trigger, an operation of swinging the operation device in the up-down direction in the space at a force that is great to a certain extent, for example. Thus, the user can adjust the timing of starting movement of the player character through an intuitive operation.

### Configuration 6

In a configuration 6 based on the above configuration 5, the computer may further execute: in a case where the magnitude of the acceleration applied in the up-down direction in the space exceeds the first threshold and then becomes smaller than the first threshold, or in a case where the magnitude of the acceleration exceeds a second threshold greater than the first threshold and then becomes smaller than the second threshold, stopping the action in which the player character having the ball moves on the field.

According to the above configuration, processing for moving the player character and processing for stopping the player character can be controlled with enhanced response.

### Configuration 7

In a configuration 7 based on any one of the above configurations 1 to 6, the ball sport game may be a basketball game. The action of moving on the field may be a dribbling action involving movement of the player character.

According to the above configuration, it is possible to cause the player character to do a dribbling action involving movement, through an operation with a feeling close to dribbling for a user.

### Configuration 8

In a configuration 8 based on any one of the above configurations 1 to 7, the ball sport game may be a basketball game. The computer may further execute: in a case where the orientation regarding the pitch in the space is in an upward predetermined range and an upward predetermined angular velocity in the space is applied to the operation device, causing the player character having the ball to start a jump action; and causing the player character having the ball to do the shot action, on the second condition that a predetermined angular velocity is applied to the operation device while the player character having the ball is doing the jump action.

According to the above configuration, it is possible to cause the player character to do a shot action through an operation simulating a shot motion in basketball, thus improving amusement of the basketball game.

### Configuration 9

In a configuration 9 based on the above configuration 8, the computer may further execute: in a case where the shot action has been done, determining a trajectory of the ball corresponding to the shot action, based on at least the orientation regarding the pitch in the space.

According to the above configuration, the way of moving the operation device when causing the player character to do a shot action can be appropriately reflected in a shot trajectory in basketball.

### Configuration 10

In a configuration 10 based on any one of the above configurations 1 to 9, the computer may further execute: identifying an orientation of the operation device regarding a yaw in the space; and in a case where the first condition is satisfied, causing the player character having the ball to do an action of moving in a direction according to the orientation regarding the yaw in the space, on the field in the game space.

According to the above configuration, it is possible to move the player character through an intuitive operation while being hardly influenced by the way of holding with respect to the predetermined axis.

The configurations described above may be applied to a game processing method, a game system, and a game apparatus.

According to the exemplary embodiment, it is possible to improve operability in a ball sport game that progresses through an operation of moving an operation device.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game screen according to an exemplary embodiment;

FIG. 9 shows a non-limiting example of the posture of a user (the orientation of the controller) during game play;

FIG. 10 illustrates a non-limiting example of a flow of a game in the exemplary embodiment;

FIG. 11 shows a non-limiting example of a vertical swing operation;

FIG. 12 shows a non-limiting example of a game screen according to the exemplary embodiment;

FIG. 13 shows a non-limiting example of a shot mode shift operation;

FIG. 14 shows a non-limiting example of a game screen according to the exemplary embodiment;

FIG. 15 shows a non-limiting example of a swing-up operation;

FIG. 16 shows a non-limiting example of a game screen according to the exemplary embodiment;

FIG. 17 shows a non-limiting example of a swing-down operation;

FIG. 18 shows a non-limiting example of a game screen according to the exemplary embodiment;

FIG. 19 shows a non-limiting example of the way of holding the controller;

FIG. 20 shows a non-limiting example of the way of holding the controller;

FIG. 21 shows a non-limiting example of the way of holding the controller;

FIG. 22 shows a non-limiting example of the way of holding the controller;

FIG. 23 illustrates a non-limiting example of a real space pitch orientation;

FIG. 24 shows a non-limiting example of a swing-down operation;

FIG. 25 shows a non-limiting example of a swing-down operation;

FIG. 26 illustrates a non-limiting example of shift between a moving state and a stopped state;

FIG. 27 illustrates a non-limiting example of shift between a moving state and a stopped state;

FIG. 28 illustrates a non-limiting example of shift between a moving state and a stopped state;

FIG. 29 is a memory map showing a non-limiting example of various data stored in a DRAM 85;

FIG. 30 is a non-limiting example of a flowchart showing the details of game processing according to the exemplary embodiment;

FIG. 31 is a non-limiting example of a flowchart showing the details of an orientation calculation process;

FIG. 32 is a non-limiting example of a flowchart showing the details of a stopped state process;

FIG. 33 is a non-limiting example of a flowchart showing the details of a moving state process;

FIG. 34 is a non-limiting example of a flowchart showing the details of a shot mode process;

FIG. 35 is a non-limiting example of a flowchart showing the details of a shot preparation process;

FIG. 36 is a non-limiting example of a flowchart showing the details of a jumping state process; and

FIG. 37 is a non-limiting example of a flowchart showing the details of a shooting state process.

### DETAILED DESCRIPTION OF NON-LIMITING EXAMPLE EMBODIMENTS

Hereinafter, an exemplary embodiment will be described.

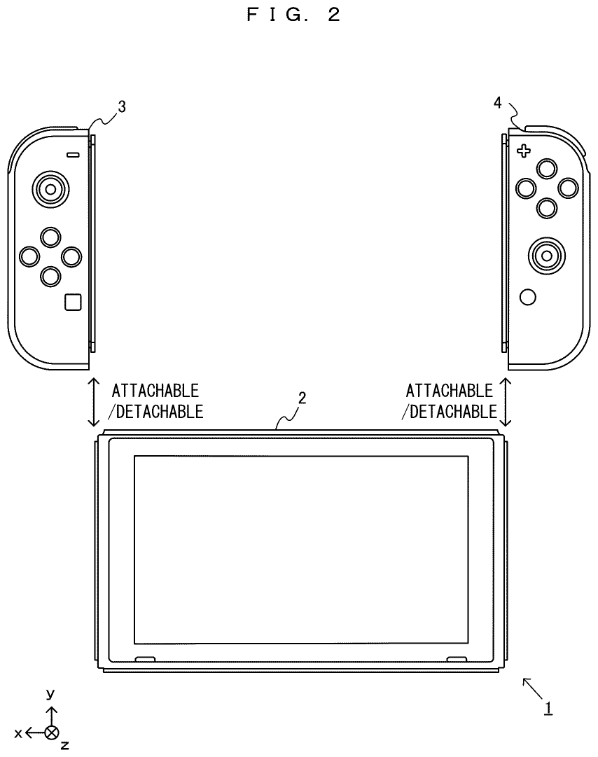

A game system according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

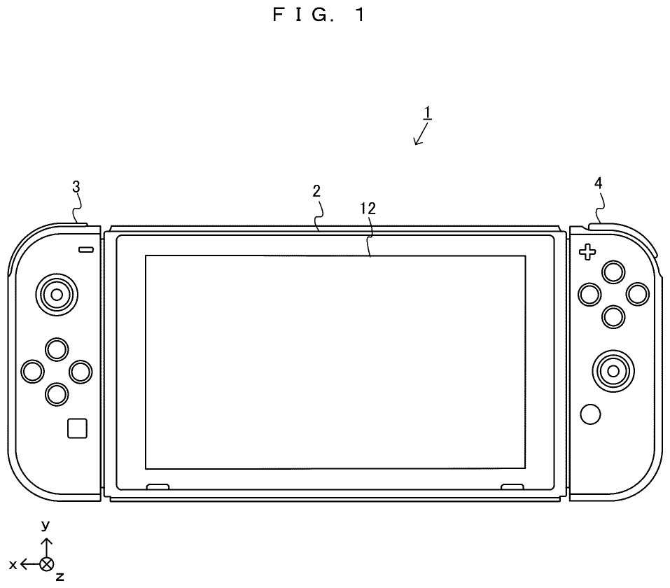

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

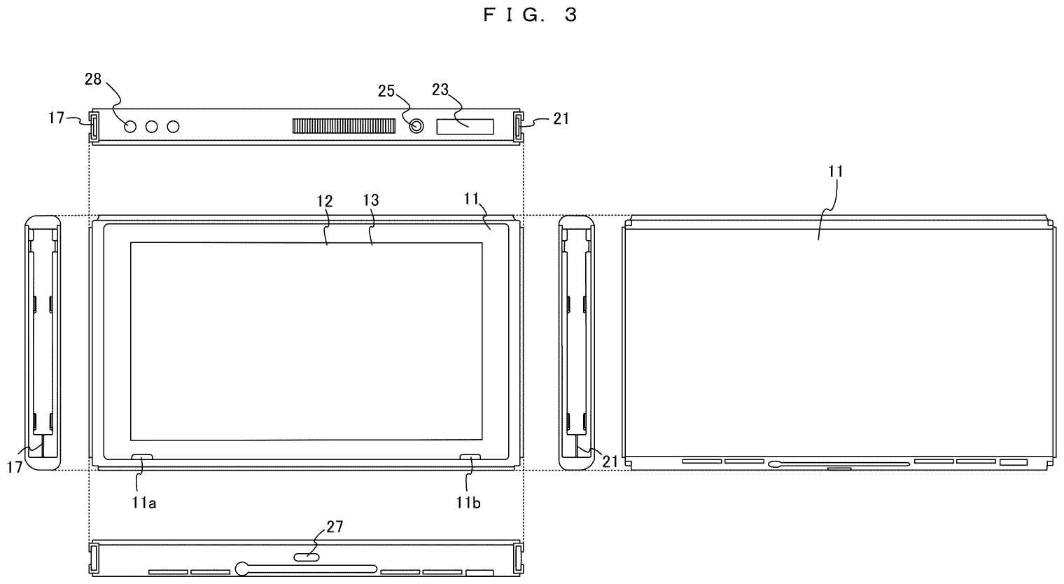

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

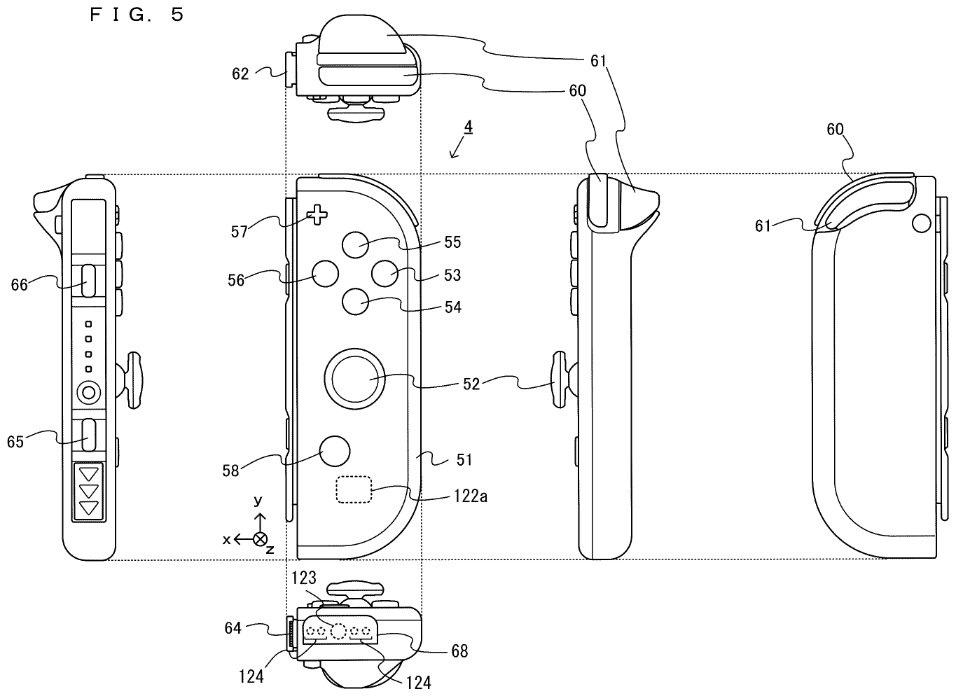

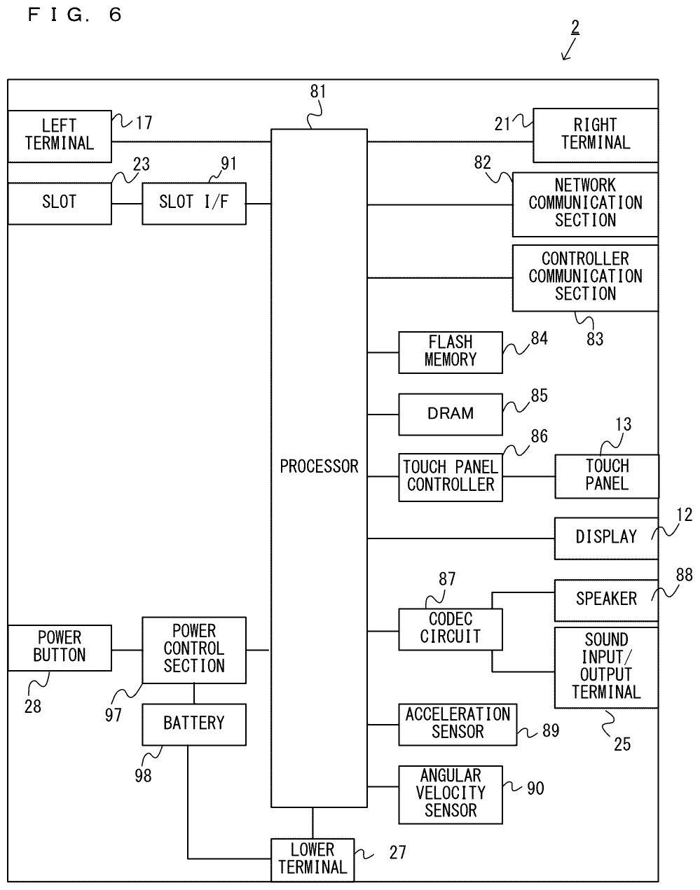

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

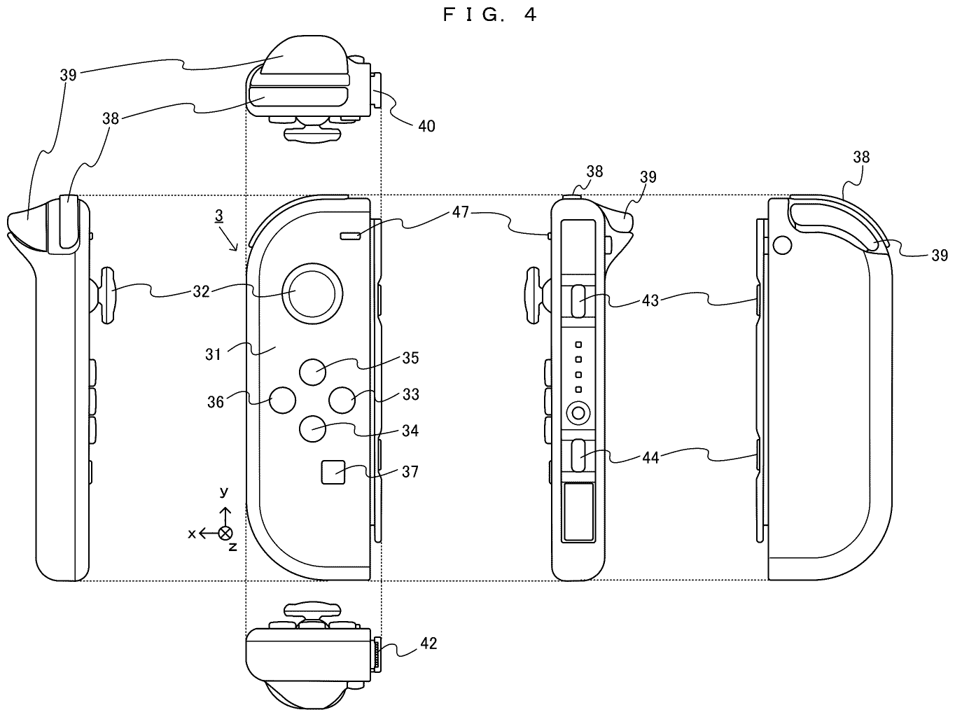

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a z-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the z-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

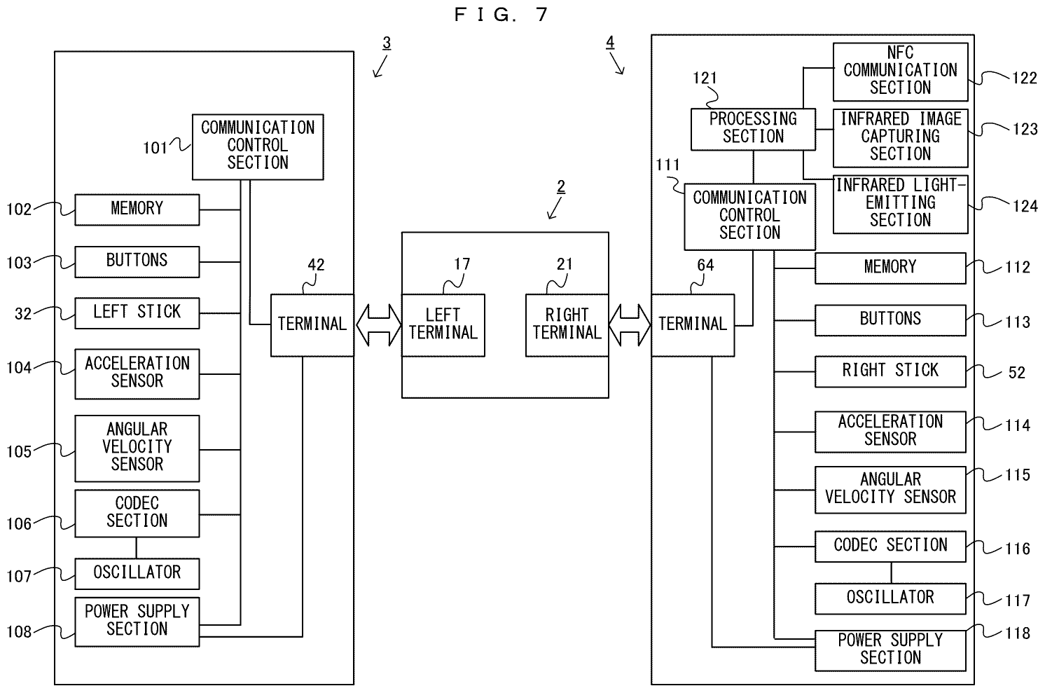

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 based on the operation data. Further, the main body apparatus 2 can calculate information regarding the motion and/or the orientation of the left controller 3 based on the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### Outline of Game Processing in Exemplary Embodiment

Next, the outline of operation of the game processing executed by the game system 1 (hereinafter, may be referred to as “game apparatus 1”) according to the exemplary embodiment will be described. As described above, in the game system 1, the main body apparatus 2 is configured such that each of the left controller 3 and the right controller 4 is attachable thereto and detachable therefrom. In a case of playing the game with the left controller 3 and the right controller 4 attached to the main body apparatus 2, a game image is outputted to the display 12. In a case where the main body apparatus 2 alone with the left controller 3 and the right controller 4 detached therefrom is mounted on the cradle, the main body apparatus 2 can output a game image to a stationary monitor or the like via the cradle. In the exemplary embodiment, the case of playing the game in the latter manner will be described as an example. Specifically, the main body apparatus 2 alone with the left controller 3 and the right controller 4 detached therefrom is mounted on the cradle, and the main body apparatus 2 outputs a game image and the like to a stationary monitor or the like via the cradle.

In the following description, the left controller 3 and the right controller 4 may be collectively referred to as “controller”.

### Assumed Game

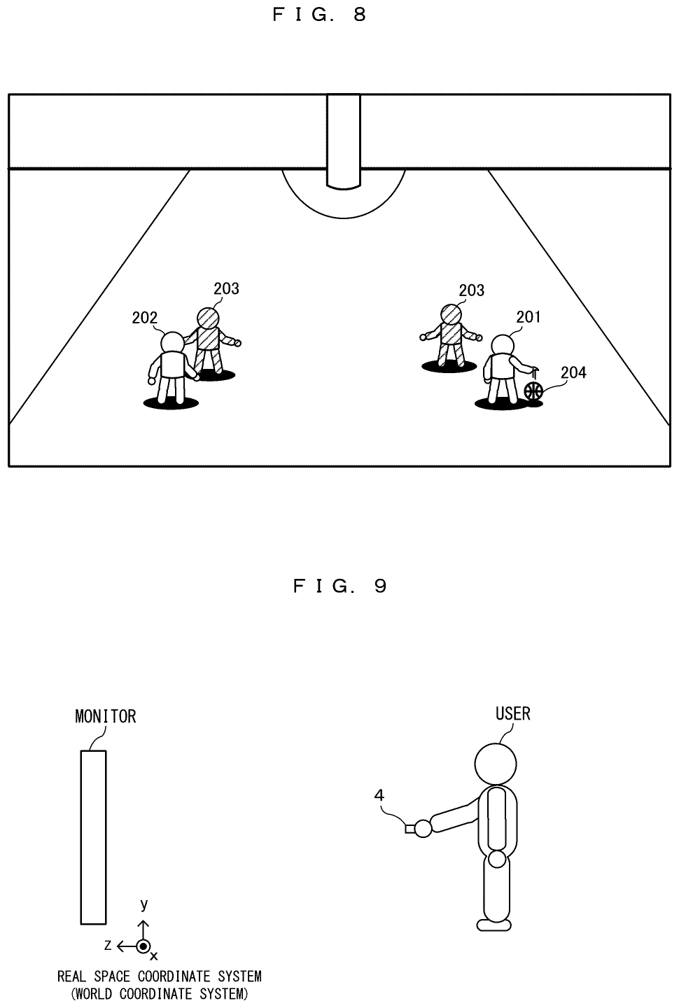

Next, the outline of a game assumed in the exemplary embodiment will be described. The game assumed in the exemplary embodiment is a ball sport game. In the exemplary embodiment, as an example of a ball sport, a basketball game will be described. In the exemplary embodiment, it is assumed that two-vs-two competition is performed in the basketball game. FIG. 8 shows an example of a game screen in the basketball game (hereinafter, simply referred to as this game) in the exemplary embodiment. FIG. 9 shows an example of the posture of a user (the orientation of the controller) during play of this game. Both figures show a state just after game play is started.

In this game, the user operates a player character object (hereinafter, referred to as PC), using the right controller 4 or the left controller 3. In the exemplary embodiment, in starting play of the game, the controller is set in an initial orientation (reference orientation) so that the distal end side of the controller used in play is directed toward a monitor (a z-axis positive-direction side in a real space coordinate system in FIG. 9, hereinafter, referred to as a real space frontward direction) and the main surface of the controller is directed in the upward direction in the real space (a y-axis positive-direction side in the real space coordinate system in FIG. 9, hereinafter, referred to as a real space upward direction). The distal end side of the controller is, specifically, the side where the first R button 60 and the ZR button 61 are provided (y-axis positive-direction side in FIG. 5), in a case of using the right controller 4 in play. In a case of using the left controller 3 in play, the distal end side is the side where the first L button 38 and the ZL button 39 are provided (y-axis positive-direction side in FIG. 4). In the following description, basically, it is assumed that the user plays using the right controller 4, and as necessary, a case of using the left controller 3 will be mentioned. Hereinafter, for convenience of description, the y axis of each controller in FIG. 4 and FIG. 5 is referred to as a “controller front axis”. The x axis and the z axis of each controller in FIG. 4 and FIG. 5 are referred to as a “controller transverse axis” and a “controller vertical axis”, respectively.

Next, a screen example in FIG. 8 will be described. In FIG. 8, on a field in a virtual game space simulating a basketball court, a PC 201, an ally character 202, and two enemy team characters (hereinafter, referred to as EC) 203 are present. A part of a goal post is displayed on the far side in the screen. The PC 201 has a ball 204 and is dribbling at the present position. Here, it is assumed that game play is started in a state in which the player character has a ball.

### Outline of Stopped State and Moving State

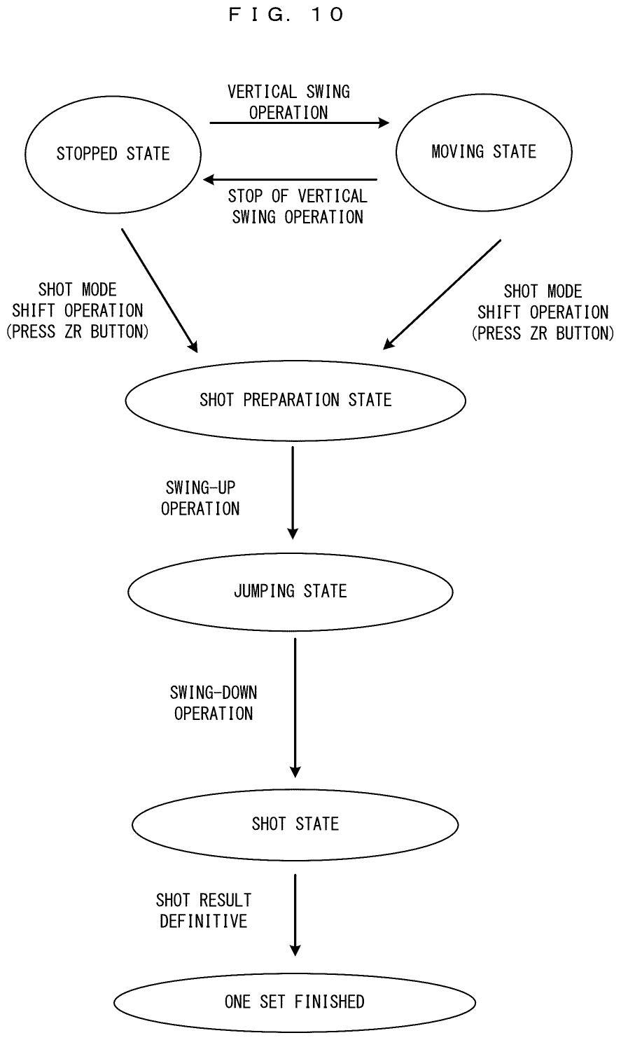

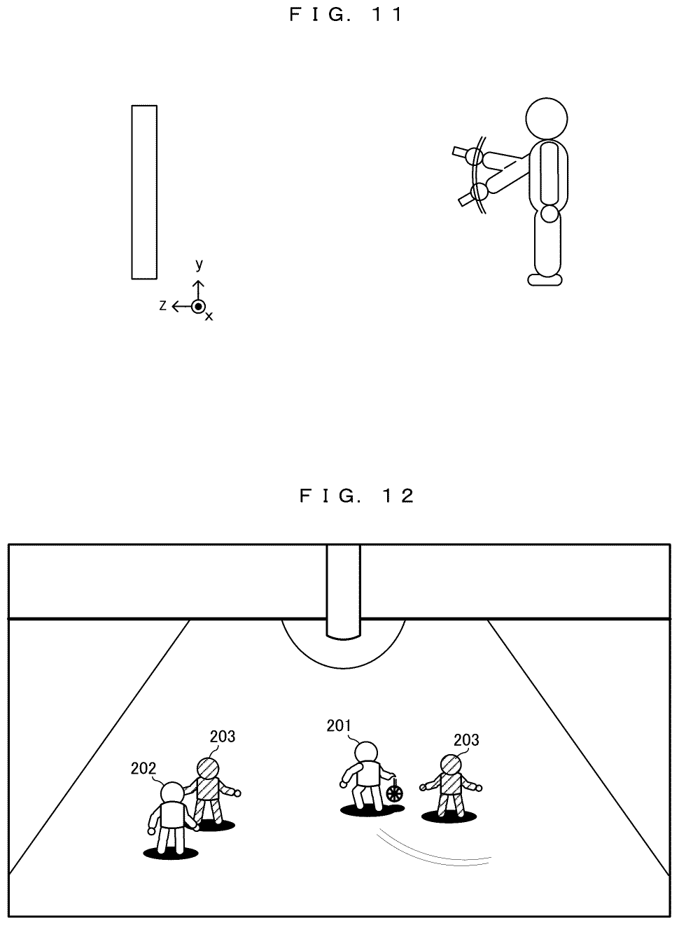

Next, a rough flow of play and operation examples in this game will be described. FIG. 10 is a schematic view showing shift of the state of the PC 201 (hereinafter, PC state) through the flow of play of this game. The state of the PC 201 just after start of game play is a “stopped state”. The stopped state is a state in which the PC 201 is doing a dribbling action while stopping at the present position without moving. In the stopped state, as shown in FIG. 11, while the distal end side of the right controller 4 is approximately directed in the frontward direction, if the user performs an operation of swinging the right controller 4 in the up-down direction in the real space (hereinafter, vertical swing operation), the PC state can be shifted to a “moving state”. Thereafter, the moving state is kept while the vertical swing operation is continuing. The moving state is a state in which the PC 201 is moving while dribbling toward a predetermined target position on the field, i.e., a predetermined position under a goal. In other words, this state is a state in which the PC 201 is doing a dribbling action while moving. FIG. 12 shows a screen example in which the PC 201 is in the moving state. In FIG. 12, the PC 201 is moving toward a position under the goal while avoiding the EC 203.

A movement route of the PC 201 in a moving state is calculated as follows. First, the straight distance from the present position of the PC 201 to the target position is calculated as a route. Then, if an obstacle such as an EC is present on the straight route, a route for detouring around the obstacle is calculated. If there is no obstacle, the original straight route is used.

When the PC 201 is in a moving state, if the user stops the vertical swing operation, the PC 201 can be shifted to a stopped state. When the PC 201 is shifted to a stopped state, movement of the PC 201 is stopped and the PC 201 is doing a dribbling action at the present position.

### Steal Action

Here, a “steal action” that the EC 203 does will be described. In this game, the EC 203 can do a “steal action” which is an action for stealing the ball 204 from the PC 201. The steal action is an action of swinging a hand in a horizontal direction so as to steal the ball 204 at a close distance, for example. In the exemplary embodiment, when the EC 203 does a steal action to the PC 201, if the state of the PC 201 is a moving state, the ball 204 is stolen. On the other hand, if the PC 201 is in a stopped state, the steal action can be blocked without the ball 204 being stolen. That is, the moving state can be considered to be a state in which there is a risk that the ball 204 is stolen by an EC.

### Shot Mode

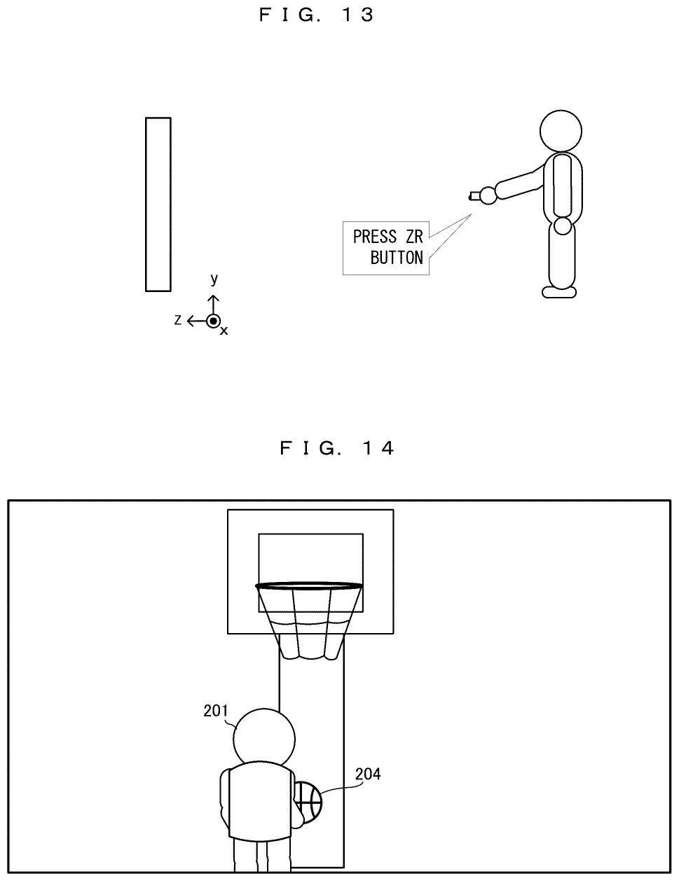

Returning to FIG. 10, next, a shot will be described. When the PC 201 is in a stopped state or a moving state, if the user performs a shot mode shift operation, the PC 201 shifts to a shot mode. The shot mode is a mode for making a shot, and includes three states, i.e., a “shot preparation state”, a “jumping state”, and a “shot state”. When the user performs a shot mode shift operation, first, the PC state shifts to the “shot preparation state”. The shot preparation state is a state in which the PC 201 is standing while holding the ball 204. In the exemplary embodiment, the shot mode shift operation is to press the ZR button 61 in a case of using the right controller 4, or to press the ZL button 39 in a case of using the left controller 3. For example, as shown in FIG. 13, when the user presses the ZR button 61, a shot mode screen as shown in FIG. 14 is displayed. Before shift to the shot mode, a virtual camera is set at a position where a certain wide range in the field is covered, as shown in FIG. 8 or FIG. 12. On the other hand, in the shot mode, the virtual camera moves to a position that is backward of the PC 201 and where a goal hoop is displayed within the screen, and the screen is displayed in a state of being zoomed in to a certain extent.

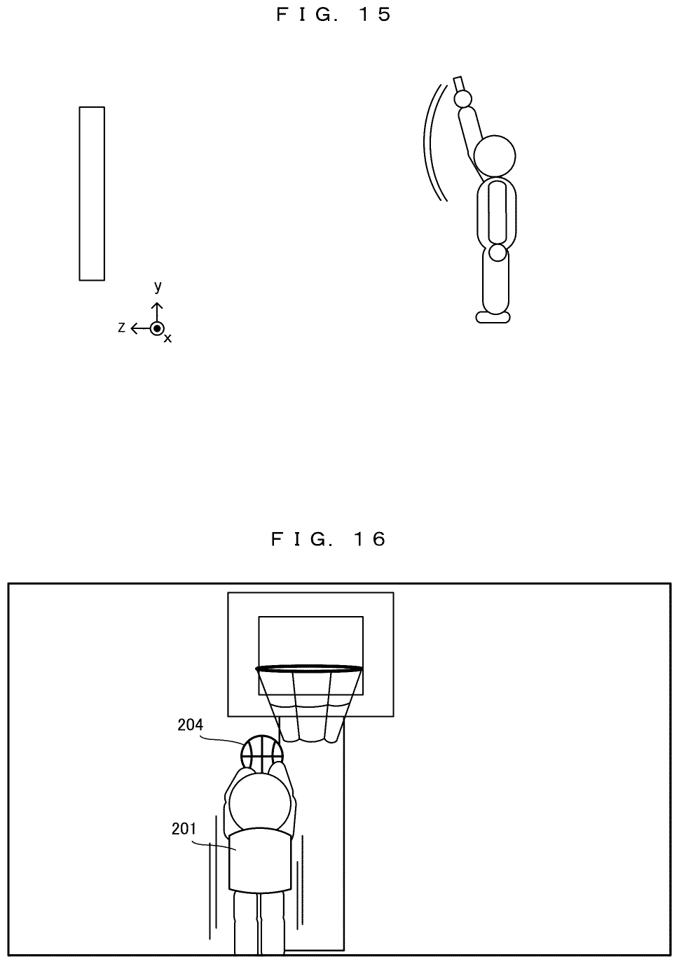

If the user performs a “swing-up operation” within a predetermined time after the PC 201 shifts to a shot preparation state, the PC state shifts to a “jumping state”. The swing-up operation is an operation of swinging up the right controller 4 in the real space upward direction, as shown in FIG. 15. The jumping state is a state in which the PC 201 is doing an action of jumping (hereinafter, jump action) while lifting up the ball, as shown in FIG. 16. In the exemplary embodiment, a case where the swing-up operation is not performed within the predetermined time is regarded as failing to shoot at this time (regarded as a kind of violation).

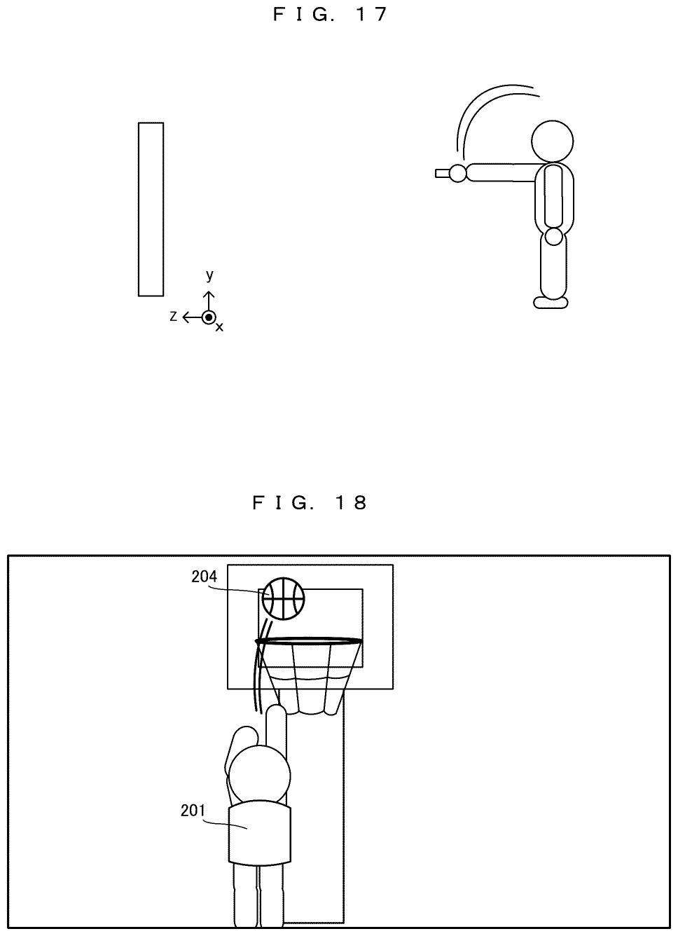

The jumping state continues until a jump motion finishes (the PC 201 lands). During the jumping state, if the user performs an operation of swinging down the right controller 4 in the real space frontward direction (hereinafter, swing-down operation) as shown in FIG. 17, the PC state shifts to a “shot state”. The shot state is a state after the PC 201 makes a shot, as shown in FIG. 18. A movement trajectory of the ball 204 in the shot state is calculated based on an acceleration and an angular velocity detected by the right controller 4 when the swing-down operation is performed. In the exemplary embodiment, a case where the swing-down operation is not performed during the jumping state is also regarded as failing to shoot.

Thereafter, a shot result is determined between a case where the ball 204 goes into the goal hoop so that the shot succeeds and a case where the ball 204 does not go into the goal hoop so that the shot fails, and thus one set of play is finished. Thereafter, a next set of play is started and a screen as shown in FIG. 8 is displayed.

Points to be obtained when a shot succeeds is determined based on the position of the PC 201 on the field when the PC 201 is shifted to the shot preparation state. For example, in a case where a shot is made in an area located outside a semicircle area under the goal and set as a “three-point area” on the field, three points are obtained.

As described above, in the game in the exemplary embodiment, while the PC 201 is moved toward the goal through a vertical swing operation, the PC 201 is shifted to a shot preparation state at an appropriate timing, and a series of operations including a swing-up operation and a swing-down operation is performed to make a shot, and one set of play is finished with the shot result.

### Way of Holding

The vertical swing operation is an operation of swinging the right controller 4 in the real space up-down direction with such an orientation that the distal end side of the right controller 4 is directed toward the monitor, as shown in FIG. 11. In this operation, as seen from the user, the frontward direction of the controller front axis and a z-axis positive direction (real space frontward direction) in the real space coordinate system in FIG. 11 coincide with each other. Meanwhile, the controller has a substantially flat-plate shape elongated in the longitudinal direction, as shown in FIG. 4 or FIG. 5. Therefore, while the front axis of the controller is directed in the real space frontward direction, it is assumed that the user plays by such a way of holding the controller that an orientation around the front axis can change.

FIG. 19 to FIG. 22 show examples of ways of holding the controller assumed in the exemplary embodiment, in a case of using the right controller 4. Each of FIG. 19 to FIG. 22 shows a state in which the user is grasping the right controller 4 with its distal end side directed in the real space frontward direction (monitor side). In the example shown in FIG. 19, the right controller 4 is held by such a way that the right controller 4 is grasped with its main surface (the surface where the right stick 52 and the operation buttons 53 to 56 are provided) directed toward the real space upward direction. Hereinafter, the way of holding (the orientation of the controller) as shown in FIG. 19 is referred to as “plane holding”. In a case of using this way of holding, the direction of the controller transverse axis and the direction of the controller vertical axis coincide with the left-right direction and the up-down direction in the real space. That is, the pitch direction (around the x axis in FIG. 4 and FIG. 5) of the controller and the pitch direction in the real space (to be exact, a world space regarded as the real space in the game processing) correspond to each other.

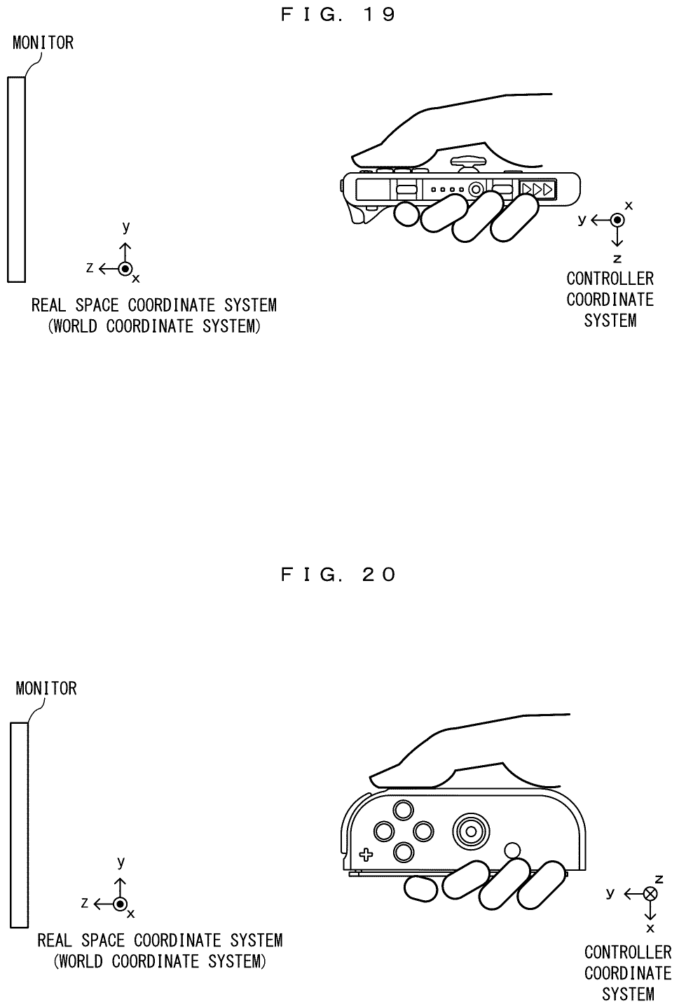

In the example shown in FIG. 20, the right controller 4 is held by such a way that the right controller 4 is grasped with its left side surface (the surface where the second L button 65 and the second R button 66 are provided) directed in the downward direction in the real space (hereinafter, real space downward direction). In other words, the orientation of the right controller 4 is such an orientation that the right controller 4 is rotated by 90° about the front axis from the orientation shown in FIG. 19. Hereinafter, the way of holding as shown in FIG. 20 is referred to as “vertical holding”. In a case of using this way of holding, the direction of the controller transverse axis corresponds to the up-down direction in the real space, and the direction of the controller vertical axis corresponds to the left-right direction in the real space. Specifically, the rightward direction of the controller transverse axis corresponds to the upward direction in the real space, and the leftward direction of the controller transverse axis corresponds to the downward direction in the real space. The upward direction of the controller vertical axis corresponds to the leftward direction in the real space, and the downward direction of the controller vertical axis corresponds to the rightward direction in the real space. The yaw direction (around the z axis in FIG. 4 and FIG. 5) of the controller corresponds to the pitch direction in the real space.

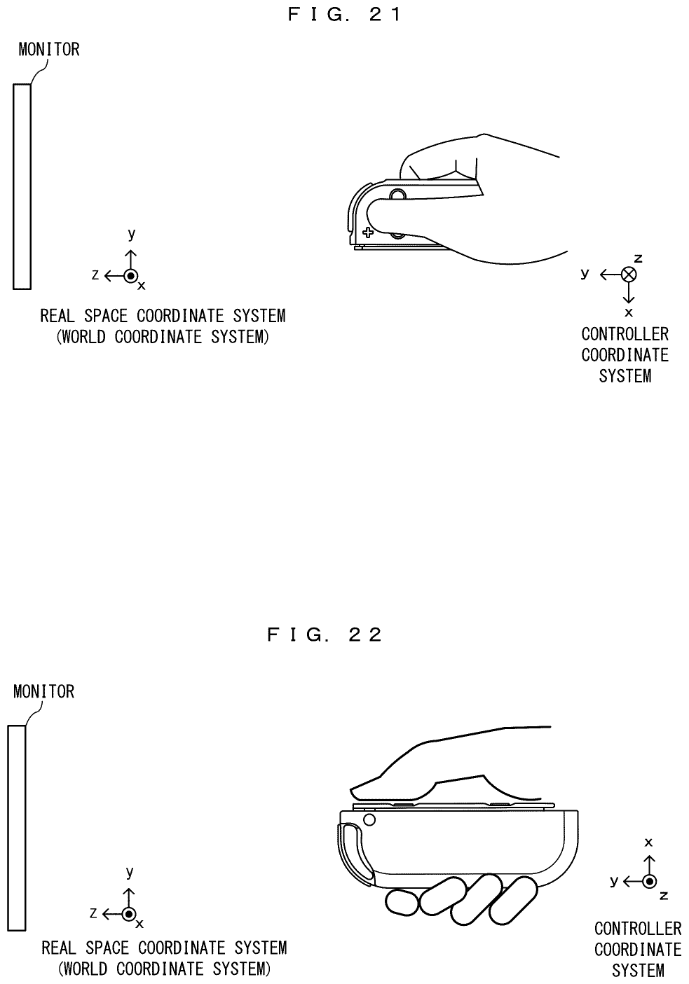

FIG. 21 shows another example of “vertical holding” described above. That is, although the orientation of the right controller 4 is the same as that in FIG. 20, the way of grasping is different from that in FIG. 20. In FIG. 20, the right controller 4 is grasped with the thumb put on a side surface, whereas in FIG. 21, the right controller 4 is grasped with the wrist turned by 90° while using the same way of holding as shown in FIG. 19. In the exemplary embodiment, both of the cases shown in FIG. 20 and FIG. 21 are regarded as “vertical holding”. In other words, in a case where the wrist of the hand holding the controller as shown in FIG. 19 is turned by 90° into a state as shown in FIG. 21, the way of holding is changed from “plane holding” to “vertical holding”.

In the example shown in FIG. 22, the right controller 4 is held by being grasped with its left side surface directed in the real space upward direction, conversely to FIG. 20. Hereinafter, the way of holding as shown in FIG. 22 is referred to as “reverse vertical holding”. Also in a case of using this way of holding, the direction of the controller transverse axis corresponds to the up-down direction in the real space, and the direction of the controller vertical axis corresponds to the left-right direction in the real space. The yaw direction of the controller corresponds to the pitch direction in the real space. However, in contrast to the case of FIG. 20, the rightward direction of the controller transverse axis corresponds to the downward direction in the real space, and the leftward direction of the controller transverse axis corresponds to the upward direction in the real space. The upward direction of the controller vertical axis corresponds to the rightward direction in the real space, and the downward direction of the controller vertical axis corresponds to the leftward direction in the real space.

Although not shown, conversely to the case of FIG. 19, the right controller 4 may be held by such a way that the right controller 4 is grasped with its main surface directed in the real space downward direction. This way of holding is referred to as a “reverse plane holding”. In the way of “reverse plane holding”, it is difficult to operate the analog stick and various buttons at the main surface, and therefore in the exemplary embodiment, it is assumed that play is not performed using “reverse plane holding”. However, in another exemplary embodiment, play may be performed using “reverse plane holding”, depending on the content of a game. Also in this case, the control described below is applicable.

The correspondence relationship between the yaw direction (transverse direction)/pitch direction (vertical direction) in the real space and the yaw direction/pitch direction of the controller can change in accordance with difference in the way of holding the controller as described above. Considering such change in the correspondence relationship, in the exemplary embodiment, the way of holding the controller is determined at all times so that the orientation of pitch of the controller front axis in the real space (hereinafter, real space pitch orientation) can be identified. Specifically, control is performed so as to update the setting of the correspondence relationship between a direction in the real space coordinate system and a direction in the controller coordinate system in accordance with the way of holding (the orientation around the controller front axis) at each time. In other words, under the orientation of the controller at each time, association of the up-down direction in the real space with the direction in the controller coordinate system is updated at all times. For example, in a case of plane holding as shown in FIG. 19, setting of the correspondence relationship is updated so that the pitch direction in the controller coordinate system and the pitch direction in the real space coordinate system are associated with each other. In a case of vertical holding or reverse vertical holding as shown in FIG. 20 or FIG. 22, setting of the correspondence relationship is updated so that the yaw direction in the controller coordinate system is associated with the pitch direction in the real space coordinate system. In the exemplary embodiment, setting of the correspondence relationship is updated at all times as described above, and determination for the vertical swing operation is performed based on the acceleration in the pitch direction in the real space. The setting method for the correspondence relationship may be any method. For example, the correspondence relationship may be defined as a transformation matrix for transforming yaw rotation of the controller to pitch rotation.

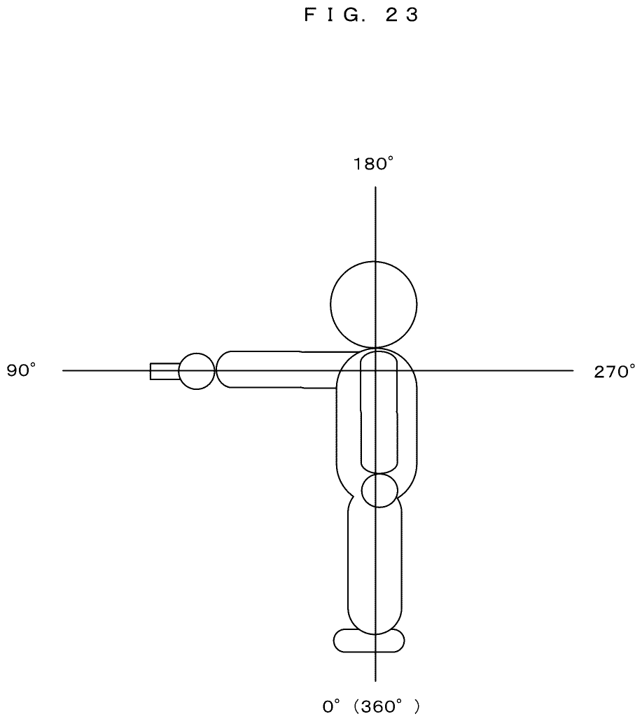

In the exemplary embodiment, a pitch angle as shown in FIG. 23, for example, is calculated as the real space pitch orientation. In the example shown in FIG. 23, the pitch angle is calculated as 0° (or) 360° in a case where the distal end side of the controller is directed exactly downward, 90° in a case where the distal end side is directed frontward, 180° in a case where the distal end side is directed exactly upward, and 270° in a case where the distal end side is directed exactly rearward.

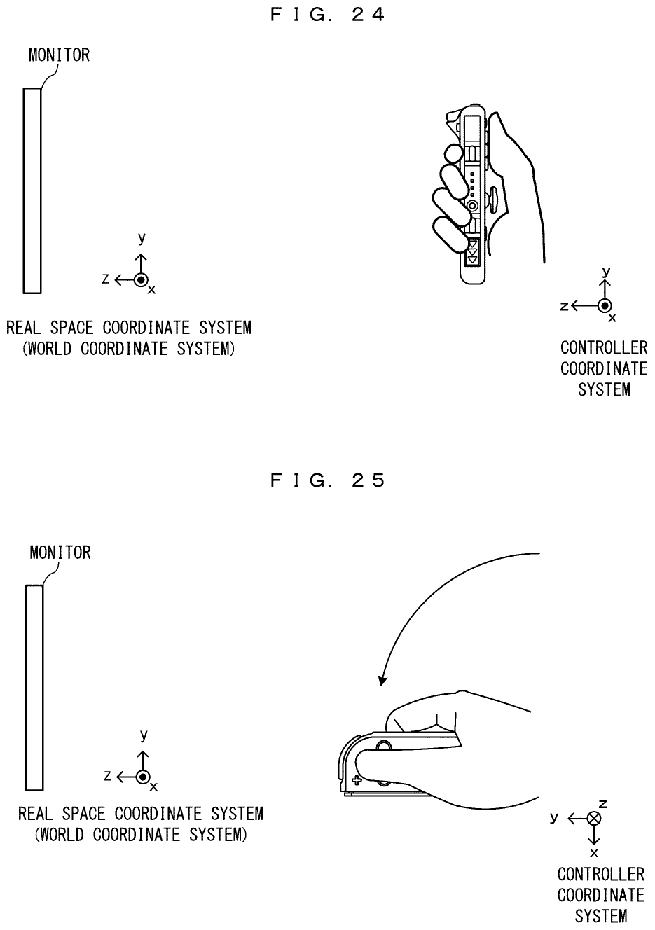

During a period until shifting to a shot state after shifting to a jumping state, the controller continues to have such an orientation that the controller front axis (the distal end side of the controller) is directed in the real space upward direction to a certain extent or more (hereinafter, referred to as upward orientation). Then, in the jumping state, the user can make a shot by performing a swing-down operation. At this time, the degree of twist of the wrist when performing the swing-down operation might differ among users. For example, it is assumed that, when the swing-up operation is performed, the left side surface of the right controller 4 is directed in the leftward direction in the real space (hereinafter, real space leftward direction), as shown in FIG. 24. In a case of performing a swing-down operation in this state, some users might perform a swing-down operation with the left side surface of the right controller 4 remaining directed in the real space leftward direction, without twisting the wrist. In performing a swing-down operation, other users might swing down the right controller 4 while twisting the wrist so that the main surface of the right controller 4 is directed in the real space leftward direction after the right controller 4 is swung down, as shown in FIG. 25. While such cases are assumed, if update of correspondence between the way of holding and the direction in the real space coordinate system as described above continues to be performed at all times during a shot operation, the correspondence relationship between the swing direction of the controller and the direction in the real space might change irrespective of the user's intention. Thus, an operation result intended by the user might not be obtained. For example, although the user intended to perform an operation of throwing a ball frontward, the ball flies in the transverse direction on the game screen. Accordingly, in the exemplary embodiment, during a period in which the controller has an upward orientation, update of the correspondence relationship between the direction of the controller and the direction in the real space performed at all times as described above is controlled to be stopped. Thus, a trajectory of a shot can be calculated while change in the orientation of the controller at the time of shooting is appropriately reflected therein.

### Switchover Control Between Moved State and Stopped State

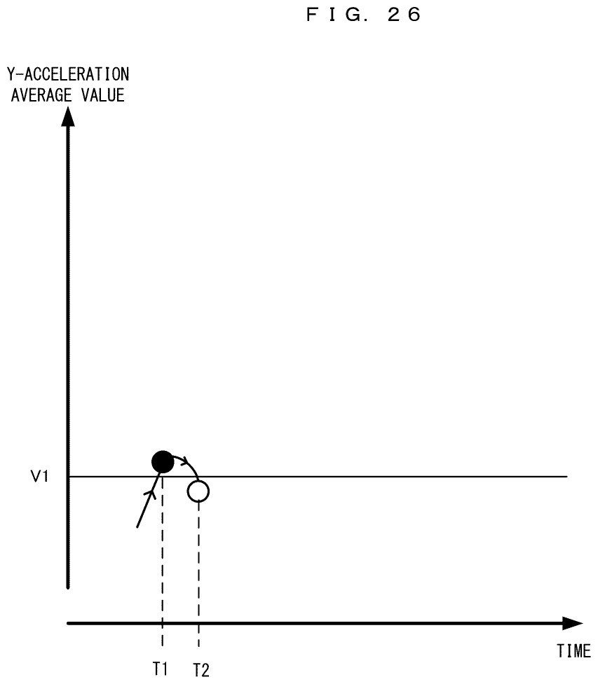

Next, control performed in the exemplary embodiment regarding shift to a stopped state/moving state will be described. As described above, it is possible to switch between a stopped state and a moving state by starting/stopping a vertical swing operation. In the exemplary embodiment, the switchover control is basically performed based on change in the acceleration (hereinafter, referred to as Y-direction acceleration) to the real space upward direction according to the correspondence relationship between the directions described above. That is, shift determination for the stopped state/moving state is performed based on change in the acceleration to the direction in the controller coordinate system that corresponds to the up-down direction in the real space. Specifically, first, Y-direction accelerations for past several frames are acquired as absolute values. Since the Y-direction accelerations are acquired as absolute values, a downward acceleration (negative acceleration) is treated as an upward acceleration with the sign inverted. Thus, all accelerations in the vertical swing operation are treated as upward accelerations. Next, an average of the Y-direction accelerations for the past several frames (hereinafter, referred to as Y-acceleration average value) is calculated. Then, when the Y-acceleration average value changes from a value smaller than a predetermined threshold to a value not smaller than the threshold, the PC state is shifted from the stopped state to a moving state, and when the Y-acceleration average value changes from a value not smaller than the threshold to a value smaller than the threshold, the PC state is shifted from the moving state to a stopped state. FIG. 26 shows the relationship between change in the Y-acceleration average value and shift of the stopped/moving state. In the graph shown in FIG. 26, the vertical axis indicates the Y-acceleration average value, and the horizontal axis indicates time. In FIG. 26, a filled circle indicates that the PC state is a moving state, and a blank circle indicates that the PC state is a stopped state. In the example shown in FIG. 26, at time T1, the Y-acceleration average value exceeds a threshold V1, so that the PC state is shifted from a stopped state to a moving state, and thereafter, at time T2, the Y-acceleration average value becomes smaller than the threshold V1, so that the PC state is shifted from the moving state to a stopped state.

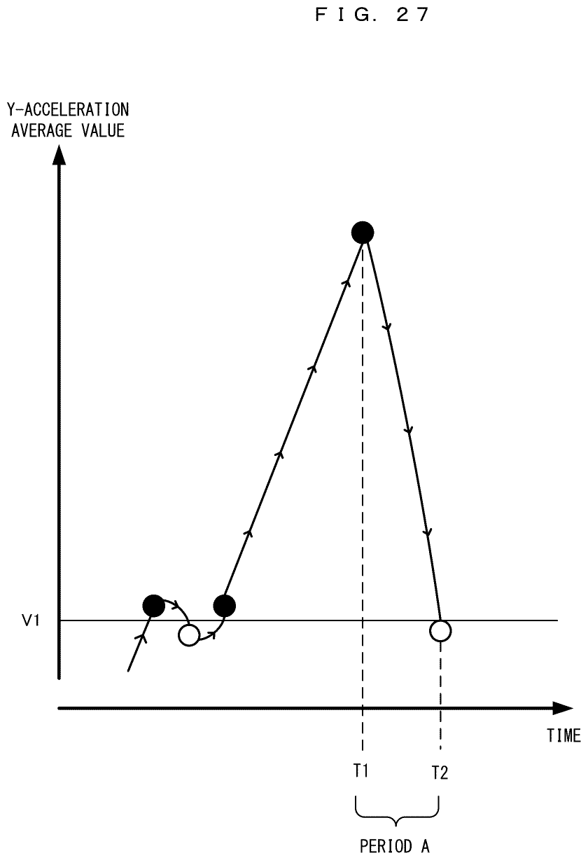

Here, it is assumed that the user continues performing a vertical swing operation of the controller strongly to a certain extent and thus the Y-acceleration average value is far from the threshold V1 to a certain extent, as shown in FIG. 27. Then, it is assumed that the user stops the vertical swing operation at time T1 in FIG. 27. In this case, if the Y-acceleration average value is determined to be smaller than the threshold V1 at time T2, a period required until the PC state shifts to a stopped state after the user stops a vertical swing operation is a period A from T1 to T2. It is considered that the period A becomes longer as the Y-acceleration average value when the vertical swing operation is stopped becomes farther from the threshold V1.

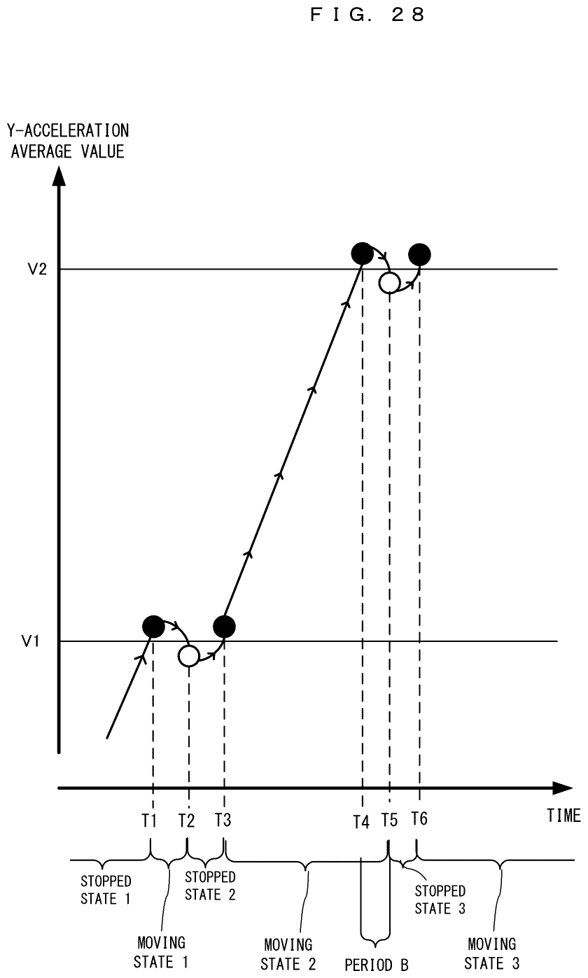

Here, considering a possibility of the steal action, it is necessary to shift from a moving state to a stopped state as quickly as possible in order to swiftly block a steal action when the steal action is attempted in the moving state. That is, considering tactics of offense and defense relevant to the steal action, it is preferable that response for shifting between a moving state and a stopped state is as fast as possible. Considering the standpoint of response as described above, in the exemplary embodiment, control is performed with two thresholds provided for shift determination for the stopped/moving state. FIG. 28 shows an example of the relationship between the switchover control and the thresholds in the exemplary embodiment. In FIG. 28, a first threshold V1 is provided, and in addition, a second threshold V2 corresponding to a Y-acceleration average value higher than the first threshold V1 is provided. In FIG. 28, a vertical swing operation is started from a stopped state, and then the PC state shifts to a moving state once in response to the Y-acceleration average value exceeding the first threshold V1 at time T1 (moving state 1). Thereafter, the Y-acceleration average value becomes smaller than the first threshold V1 at time T2, so that the PC state shifts to a stopped state (stopped state 2). Then, the Y-acceleration average value exceeds the first threshold V1 at time T3, so that the PC state shifts to a moving state again (moving state 2). Thereafter, at time T4 when the Y-acceleration average value is a little greater than the second threshold V2, the user stops the vertical swing operation. Thereafter, at time T5, the Y-acceleration average value becomes smaller than the second threshold V2, and in response thereto, the PC state shifts to a stopped state (while the Y-acceleration average value remains not smaller than the first threshold V1). In this case, a period until time T5 when the PC state shifts to a stopped state after the vertical swing operation is stopped at time T4 is a period B. The period B is shorter than the period A shown in FIG. 27. That is, as compared to the case of FIG. 27, response until the PC state shifts to a stopped state after the vertical swing operation is stopped becomes higher.

In FIG. 28, after time T5, the PC state shifts to a moving state at time T6. That is, in the example shown in FIG. 28, an operation of restarting a vertical swing operation immediately after stopping a vertical swing operation momentarily at time T5 is performed. In other words, a series of operations is performed as follows: at a timing when a steal action is attempted by the EC 203, the PC 201 is immediately shifted to a stopped state, and then, as soon as the steal action is blocked, the PC 201 is shifted to a moving state. As described above, by providing two thresholds, response for shifting to a stopped state and a moving state is enhanced. Thus, the user can enjoy tactics of offense and defense regarding the steal action, so that amusement of the game is improved.

### Determination of Trajectory of Shot

Next, the way of determining a trajectory of the ball 204 in a shot state will be described. In the exemplary embodiment, the ball 204 can be shot by performing a swing-down operation in a jumping state as described above. Then, in the exemplary embodiment, a trajectory of the ball 204 is calculated based on the orientation and the swing velocity of the controller in the swing-down operation. Specifically, a launch velocity (flight distance) of the ball 204 is determined based on the swing velocity. For example, the launch velocity is calculated so as to obtain such a trajectory that, if the swing velocity is fast (the controller is swung strongly), the ball 204 flies farther, and if the swing velocity is slow (the controller is swung weakly), the ball 204 falls in front of the goal hoop without reaching the goal hoop.

In addition, the angle of the wrist is estimated from the real space pitch orientation of the controller, and then is reflected as the launch angle of the ball 204. Specifically, in a case where the pitch angle of the real space pitch orientation is 180° (an exactly upward orientation) in FIG. 23, the launch angle of the ball 204 is calculated so as to form a fine parabola. In a case where the pitch angle indicates an orientation of slightly leaning frontward at, for example, 135° in FIG. 23, the launch angle of the ball 204 is calculated so as to form a liner-like trajectory. In a case where the pitch angle indicates an orientation of leaning rearward at, for example, 225° in FIG. 23, the launch angle of the ball 204 is calculated so as to form a high-arcing trajectory.

In the exemplary embodiment, the orientation of the controller at a frame when a swing-down operation is detected and the orientation of the controller one frame ago are compared with each other to calculate a difference in the controller transverse axis. Then, the difference is reflected as deviation of the launch direction of the ball 204 in the left-right direction.

As described above, in the exemplary embodiment, the orientation and movement regarding the up-down direction in the real space are determined irrespective of the way of holding the controller. Then, based on the determination result, determination for a vertical swing operation, a swing-up operation, and the like is performed, to control the basketball game. Thus, operability in the basketball game is improved.

### Details of Game Processing in the Exemplary Embodiment

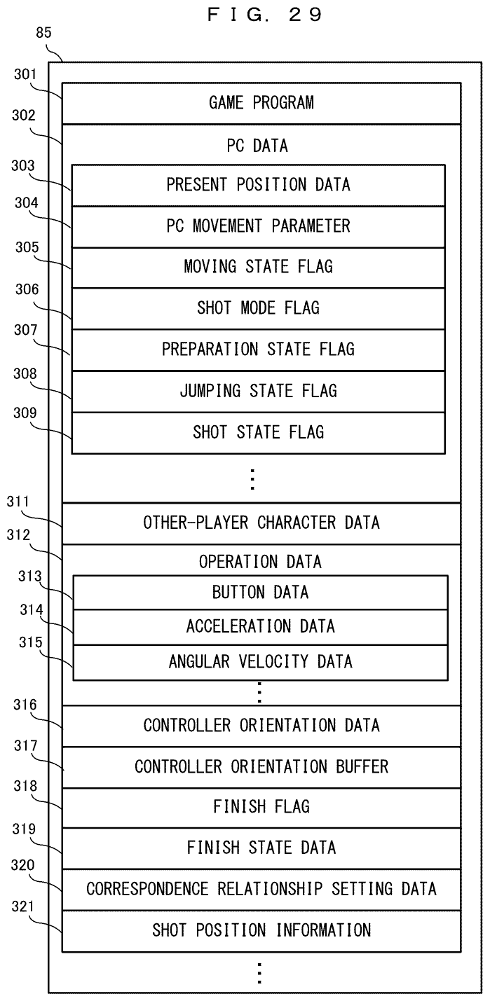

Next, with reference to FIG. 29 to FIG. 37, the game processing according to the exemplary embodiment will be described in more detail. Here, processing for controlling the PC 201 having the ball 204 will be mainly described, and description of the details of the other game processing is omitted. In the following description, a case of using the right controller 4 will be described as an example.

### Used Data

First, various data used in this game processing will be described. FIG. 29 is a memory map showing an example of various data stored in the DRAM 85 of the main body apparatus 2. The DRAM 85 of the main body apparatus 2 stores a game program 301, PC data 302, other-player character data 311, operation data 312, controller orientation data 316, controller orientation buffer 317, a finish flag 318, finish state data 319, correspondence relationship setting data 320, shot position information 321, and the like.

The game program 301 is a program for executing the game processing according to the exemplary embodiment.

The PC data 302 is data about the PC 201. The PC data 302 includes present position data 303, a PC movement parameter 304, a moving state flag 305, a shot mode flag 306, a preparation state flag 307, a jumping state flag 308, a shot state flag 309, and the like. Besides, although not shown, the PC data 302 also includes various data needed for the game processing, such as data (polygon data, etc.) indicating the outer appearance of the PC 201, various motion data (animation data) of motions to be performed by the PC 201, and the like.

The present position data 303 is data indicating the present position of the PC 201 on the field.

The PC movement parameter 304 is data to be used for movement control for the PC 201. For example, the PC movement parameter 322 includes parameters indicating the movement direction, the movement speed, and the like of the PC 201.

The moving state flag 305 is a flag indicating whether the PC state is a moving state or a stopped state. In a case of ON, the moving state flag 305 indicates that the PC state is a moving state, and in a case of OFF, the moving state flag 305 indicates that the PC state is a stopped state. The initial value of the moving state flag 305 is set at OFF.

The shot mode flag 306 is a flag indicating whether or not the present mode is the shot mode. In a case of ON, the shot mode flag 306 indicates that the present mode is the shot mode, and in a case of OFF, the shot mode flag 306 indicates that the present mode is not the shot mode. The initial value of the shot mode flag 306 is set at OFF.

The preparation state flag 307 is a flag indicating whether or not the PC state is a shot preparation state. In a case of ON, the preparation state flag 307 indicates that the PC state is a shot preparation state, and in a case of OFF, the preparation state flag 307 indicates that the PC state is not a shot preparation state. The initial state of the preparation state flag 307 is set at OFF.

The jumping state flag 308 is a flag indicating whether or not the PC state is a jumping state. In a case of ON, the jumping state flag 308 indicates that the PC state is a jumping state, and in a case of OFF, the jumping state flag 308 indicates that the PC state is not a jumping state. The initial state of the jumping state flag 308 is set at OFF.

The shot state flag 309 is a flag indicating whether or not the PC state is a shot state. In a case of ON, the shot state flag 309 indicates that the PC state is a shot state, and in a case of OFF, the shot state flag 309 indicates that the PC state is not a shot state. The initial value of the shot state flag 309 is set at OFF.

Next, the other-player character data 311 is data about character objects other than the PC 201, i.e., the ally character 202 and the ECs 203. The other-player character data 311 includes various parameters for performing operation control for the character objects.

Next, the operation data 312 is data obtained from the controller operated by the user. That is, the operation data 312 is data indicating the content of an operation performed by the user. Here, data obtained from the right controller 4 is used as an example. In a case of using the left controller 3, the operation data 312 is operation data obtained from the left controller 3. The operation data 312 includes at least button data 313, acceleration data 314, and angular velocity data 315. The button data 313 is data indicating the press states of various buttons that the right controller 4 has. The acceleration data 314 indicates a detection result from the acceleration sensor 114, and the angular velocity data 315 indicates a detection result from the angular velocity sensor 115.

Next, the controller orientation data 316 is data about the present orientation of the controller. The controller orientation data 316 includes rotation matrix data representing rotation from the reference orientation to the present orientation of the controller. The rotation matrix is a matrix in which unit vectors corresponding to the front axis, the transverse axis, and the vertical axis of the controller are represented in an xyz coordinate system and are arranged, for example. Here, in the exemplary embodiment, the reference orientation is an orientation as shown in FIG. 19, in a case of the right controller 4. That is, such an orientation that the main surface of the right controller 4 is directed in the upward direction in the real space and the left side surface thereof is directed in the leftward direction in the real space, is defined as the reference orientation. In other words, the reference orientation is such an orientation that the controller front axis coincides with the z axis in the real space coordinate system in FIG. 9 or FIG. 19, the controller transverse axis coincides with the x axis in the real space coordinate system, and the controller vertical axis coincides with the y axis in the real space coordinate system. The controller orientation data 316 also includes data indicating rotation around each of the controller front axis, the controller transverse axis, and the controller vertical axis, data indicating the orientation of each of the controller front axis, the controller transverse axis, and the controller vertical axis, and the like.

The controller orientation buffer 317 is a buffer for temporarily accumulating the controller orientation data 316 for the past predetermined period. The controller orientation buffer 317 is used for comparison between the past orientation and the present orientation of the controller, calculation of change thereof, and the like.

The finish flag 318 is a flag indicating whether or not a result of a shot has become definitive. The initial value of the finish flag 318 is set at OFF, and then is set at ON when a result of a shot has become definitive.

The finish state data 319 is data indicating whether a result of a shot is successful (points are obtained) or failure.

The correspondence relationship setting data 320 is data in which the correspondence relationship between the direction in the controller coordinate system and the direction in the real space coordinate system under the present way of holding the controller as described above is set.

The shot position information 321 is data indicating a position on the field when the PC 201 has shifted to a shot preparation state.

Besides, although not shown, various data needed for the game processing, such as data about the ball 204 (outer appearance data and a parameter for movement control) and the score status, are also generated as appropriate, and then are stored in the DRAM 85.

### Details of Processing Executed by Processor 81

Next, the details of the game processing according to the exemplary embodiment will be described. Here, a case where the user plays using the right controller 4 will be described as an example. The flowcharts shown below are merely an example of a processing procedure. Therefore, the processing order of steps may be changed as long as the same result is obtained. In addition, values of variables and thresholds used in determination steps are also merely an example, and other values may be employed as necessary.

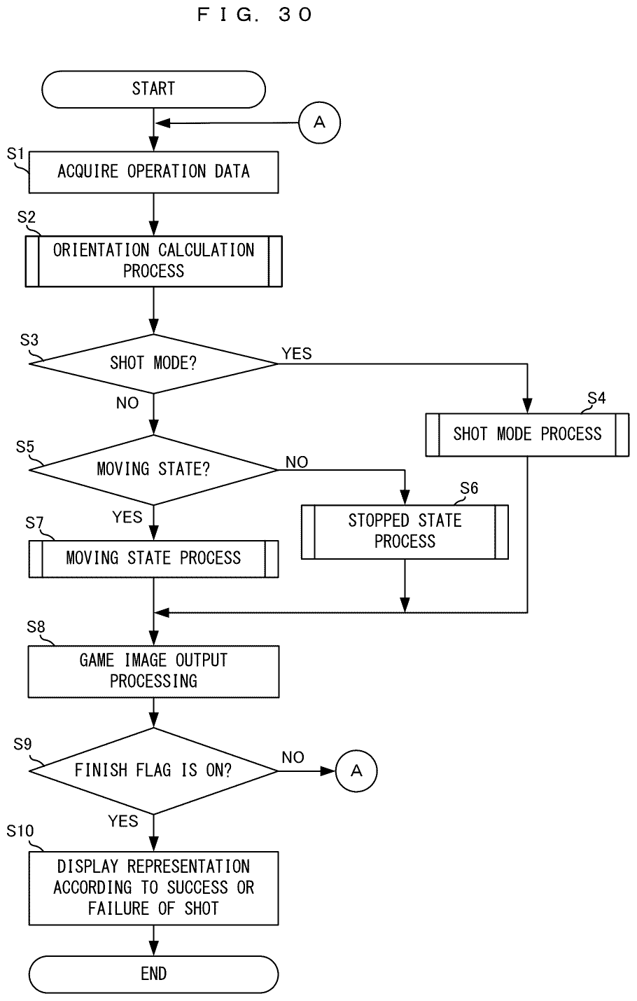

FIG. 30 is a flowchart showing the details of the game processing according to the exemplary embodiment. A processing loop through steps S1 to S9 in FIG. 30 is repeatedly executed a predetermined number of times per second in accordance with the frame rate. In FIG. 30, first, in step S1, the processor 81 acquires the operation data 312. At this time, the processor 81 has stored the content of the controller orientation data 316 calculated in the processing at the last frame, in the controller orientation buffer 317.

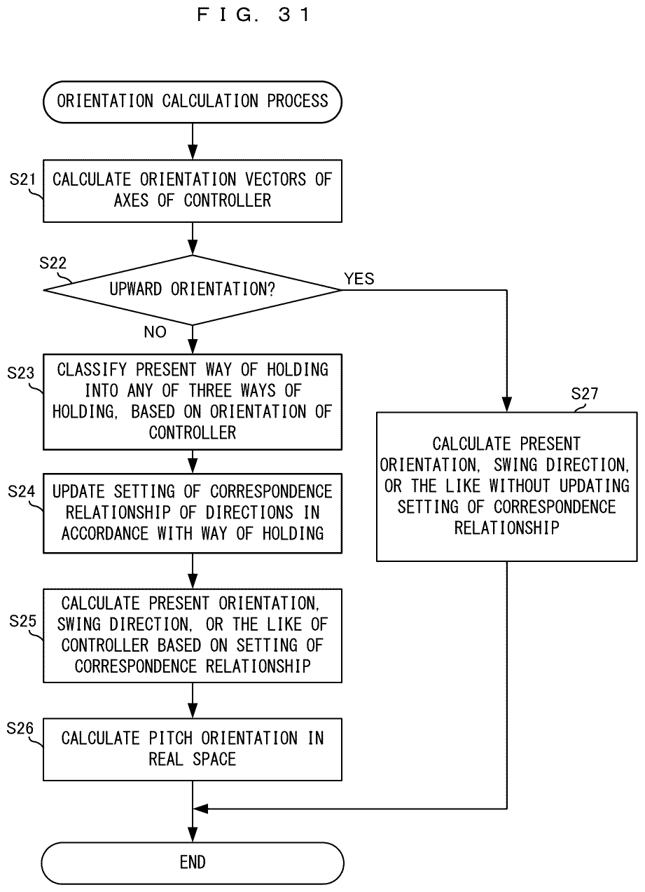

Next, in step S2, the processor 81 executes an orientation calculation process. FIG. 31 is a flowchart showing the details of the orientation calculation process. In FIG. 31, first, in step S21, the processor 81 calculates vectors (orientation vectors) indicating orientations of the controller front axis, the controller transverse axis, and the controller vertical axis of the right controller 4, based on the operation data 312.

Next, in step S22, the processor 81 determines whether or not the right controller 4 has an upward orientation. In the exemplary embodiment, if an upward component of the orientation vector of the controller front axis has a predetermined value or greater, the right controller 4 is determined to have an upward orientation. As a result of the determination, if the right controller 4 does not have an upward orientation (NO in step S22), in step S23, the processor 81 classifies the present way of holding the right controller 4 into three kinds, i.e., “plane holding”, “vertical holding”, and “reverse vertical holding” described above. For example, the classification of the way of holding is performed as follows. First, the orientations of the controller front axis, the controller transverse axis, and the controller vertical axis of the right controller 4 under the reference orientation described above are each considered using three axis vectors in a value range of −1 to +1. Here, it is assumed that, under the reference orientation, the front axis is represented as (0, 0, 1), the transverse axis is represented as (1, 0, 0), and the vertical axis is represented as (0, 1, 0). Under the reference orientation, in a case where the controller vertical axis (main surface side) is directed in the upward direction and the controller transverse axis is not tilted very much (the transverse axis is not directed upward very much), the way of holding is determined to be “plane holding”. In a case where the transverse axis (the left side surface of the right controller 4) is directed downward to a certain extent and the vertical axis is directed in the transverse direction to a certain extent, the way of holding is considered to be “vertical holding”. Here, the wording “to a certain extent” may be such an extent that allows determination for the vertical swing operation as described above, and may be an extent up to an oblique tilt of 45 degrees, for example. For example, in a case of plane holding as shown in FIG. 19, even if the controller transverse axis has an orientation tilted upward or downward by about 45 degrees from the horizontal direction, the way of holding is considered to be plane holding. Specifically, in the exemplary embodiment, if the y component of the controller vertical axis is greater than 0 (a positive value) and the absolute value of the y component of the controller transverse axis is smaller than 0.5, the way of holding is determined to be “plane holding”. In addition, for example, if the y component of the controller transverse axis is smaller than 0 (a negative value; a value indicating the downward direction) and the absolute value of the y component of the controller vertical axis is smaller than 0.5, the way of holding is determined to be “vertical holding”. In addition, for example, if the transverse axis (the left side surface of the right controller 4) is directed upward to a certain extent and the vertical axis is directed in the transverse direction to a certain extent, the way of holding is considered to be “reverse vertical holding”. This case is a case where the y component of the controller transverse axis is greater than 0 (a positive value; a value indicating the upward direction) and the absolute value of the y component of the controller vertical axis is smaller than 0.5, for example. A state in which the controller vertical axis is directed downward and the transverse axis is not tilted very much is considered to be a state of “reverse plane holding”, but as described above, it is assumed that play is not performed with this way of holding, in the exemplary embodiment. For example, update of the correspondence relationship setting data 320 described later is not performed even if the way of holding is determined to be “reverse plane holding”.

Here, the case of using the right controller 4 is shown, but in a case of using the left controller 3 in play, the relationship regarding vertical holding is reversed. For example, if a condition that would be determined as “vertical holding” for the right controller 4 is satisfied, the way of holding is determined to be “reverse vertical holding” for the left controller 3.

When the present way of holding the controller is classified into any of the three kinds of the way of holding as described above, next, in step S24, the processor 81 updates the correspondence relationship setting data 320 in accordance with the classified way of holding. That is, setting of the correspondence relationship between the direction of the right controller 4 under the reference orientation and the direction in the real space is updated. For example, in a case of “plane holding”, such a relationship that the pitch direction of the right controller 4 and the pitch direction in the real space are associated with each other is set in the correspondence relationship setting data 320. In cases of “vertical holding” and “reverse vertical holding”, such a relationship that the yaw direction of the right controller 4 and the pitch direction in the real space are associated with each other is set. Regarding “vertical holding” and “reverse vertical holding”, rotation directions are associated so as to be opposite to each other. For example, in a case of “vertical holding”, clockwise yaw rotation of the right controller 4 is associated with rotation in the upward direction in the real space, and in a case of “reverse vertical holding”, counterclockwise yaw rotation of the right controller 4 is associated with rotation in the upward direction in the real space.

Next, in step S25, based on the correspondence relationship setting data 320, the processor 81 calculates accelerations and angular velocities in the respective directions in the real space, such as a Y-direction acceleration, and based on these, the processor 81 calculates the orientation, the swing direction, and the like of the right controller 4 at present. As a result of calculation based on the correspondence relationship setting data 320, for example, in a case where the way of holding is “vertical holding”, if a swing operation in the yaw direction in the controller coordinate system is detected, the operation is considered to be a swing in the pitch direction under the reference orientation (the pitch direction in the real space).

Next, in step S26, the processor 81 calculates the real space pitch orientation based on the calculation result in step S25. In the exemplary embodiment, as shown in FIG. 23, the pitch angle in the real space is calculated.

On the other hand, as a result of the determination in step S22, if the orientation is an upward orientation (YES in step S22), in step S27, the processor 81 calculates the orientation, the swing direction, and like of the right controller 4 based on the last correspondence relationship setting data, without updating the correspondence relationship setting data.

Then, the processor 81 ends the orientation calculation process.

Returning to FIG. 30, next, in step S3, the processor 81 determines whether or not the shot mode flag 306 is ON. As a result of the determination, if the shot mode flag 306 is OFF (NO in step S3), next, in step S5, the processor 81 determines whether or not the moving state flag 305 is ON. As a result of the determination, if the moving state flag 305 is OFF (NO in step S5), in step S6, the processor 81 performs a stopped state process. On the other hand, if the moving state flag 305 is ON (YES in step S5), in step S7, the processor 81 performs a moving state process. Hereinafter, the stopped state process and the moving state process will be described sequentially.

### Stopped State Process

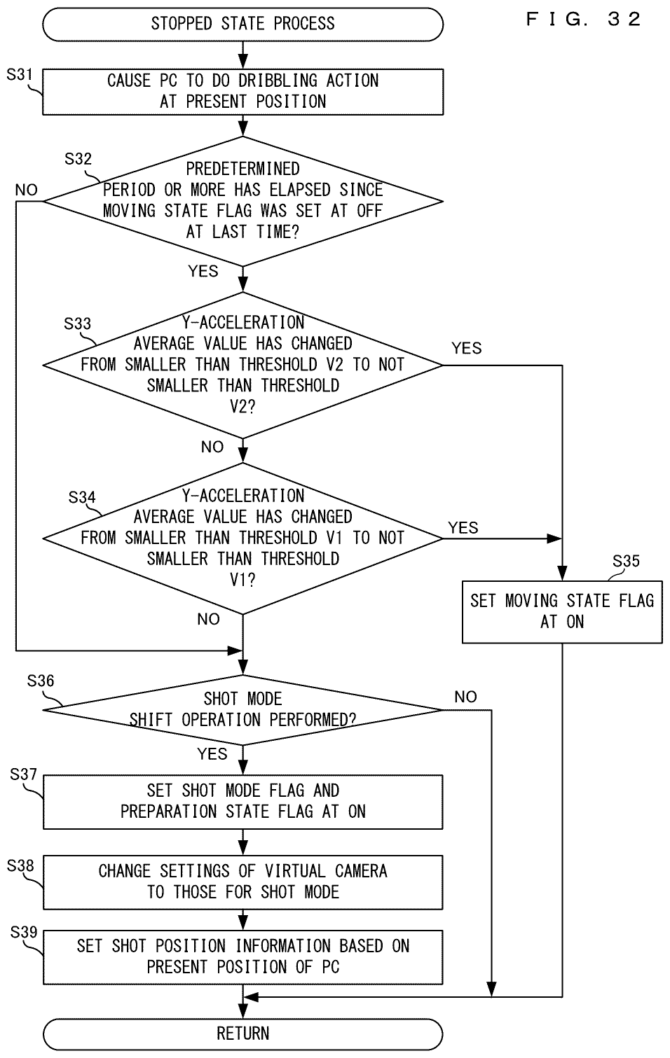

FIG. 32 is a flowchart showing the details of the stopped state process. First, in step S31, the processor 81 causes the PC 201 to do a dribbling action at the present position. Next, in step S32, the processor 81 determines whether or not a predetermined period or more has elapsed since the moving state flag 305 was set at OFF at the last time. As a result of the determination, if the predetermined period has elapsed (YES in step S32), next, in step S33, the processor 81 calculates a Y-acceleration average value based on Y-direction accelerations for past several frames included in the controller orientation buffer 317 and the Y-direction acceleration at present. Then, the processor 81 determines whether or not the Y-acceleration average value has changed to the second threshold V2 or greater from a value smaller than the second threshold V2. As a result of the determination, if the Y-acceleration average value has changed to the second threshold V2 or greater (YES in step S33), in step S35, the processor 81 sets the moving state flag 305 at ON. Then, the processor 81 ends the stopped state process. On the other hand, if the Y-acceleration average value has not changed to the second threshold V2 or greater (NO in step S33), next, in step S34, the processor 81 determines whether or not the Y-acceleration average value has changed to the first threshold V1 or greater from a value smaller than the first threshold V1. As a result of the determination, if the Y-acceleration average value has changed to the first threshold V1 or greater (YES in step S34), the processor 81 proceeds to step S35. If the Y-acceleration average value has not changed to the first threshold V1 or greater (NO in step S34), the processor 81 proceeds to step S36 described later.

On the other hand, as a result of the determination in step S32, if the predetermined period has not elapsed (NO in step S32), the processor 81 skips the processing in steps S33 to S34 and proceeds to step S36 described later. That is, control is performed so as not to cause shift between a stopped state and a moving state during a certain period after the present state has changed from the moving state to the stopped state. The reason is as follows. In a situation in which the Y-acceleration average value is close to the first threshold V1 or the second threshold V2, if shift between the stopped state and the moving state frequently occurs, operability is lowered conversely, and therefore the above control is performed for preventing this.

Next, in step S36, the processor 81 determines whether or not a shot mode shift operation has been performed, based on the operation data 312. As a result of the determination, if a shot mode shift operation has been performed (YES in step S36), in step S37, the processor 81 sets the shot mode flag 306 and the preparation state flag 307 at ON. Next, in step S38, the processor 81 changes various settings of the virtual camera to those for the shot mode.

Next, in step S39, the processor 81 sets the shot position information 321 based on the present position of the PC 201 on the field. Then, the processor 81 ends the stopped state process.

On the other hand, as a result of the determination in step S36, if a shot mode shift operation has not been performed (NO in step S36), the processor 81 skips the processing in steps S37 to S39 and ends the stopped state process.

### Moving State Process

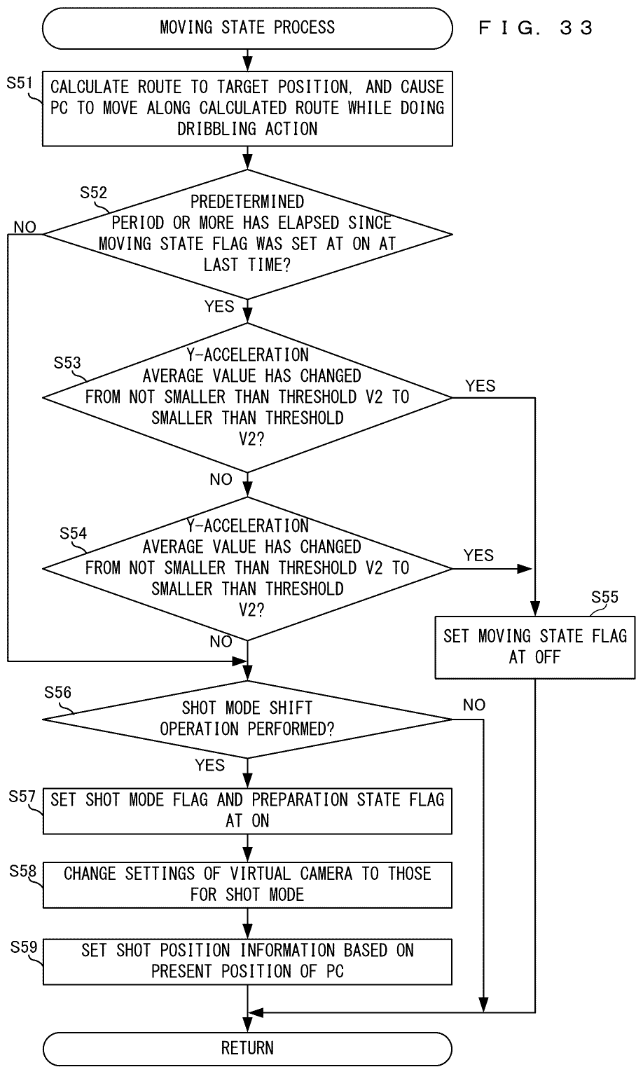

Next, the moving state process will be described. FIG. 33 is a flowchart showing the details of the moving state process. First, in step S51, the processor 81 calculates a route from the present position of the PC 201 to the above target position (e.g., under the goal). Then, the processor 81 moves the PC 201 (and the ball 204) along the route while causing the PC 201 to do a dribbling action. After the target position is reached, the processor 81 performs control so as to cause the PC 201 to do a dribbling action at the present position without moving the PC 201 any more.

Next, in step S52, the processor 81 determines whether or not a predetermined period or more has elapsed since the moving state flag 305 was set at ON at the last time. As a result of the determination, if the predetermined period has elapsed (YES in step S52), next, in step S53, the processor 81 determines whether or not the Y-acceleration average value has changed to smaller than the second threshold V2 from the second threshold V2 or greater. As a result of the determination, if the Y-acceleration average value has changed to smaller than the second threshold V2 (YES in step S53), in step S55, the processor 81 sets the moving state flag 305 at OFF. Then, the processor 81 ends the moving state process. On the other hand, if the Y-acceleration average value has not changed to smaller than the second threshold V2 (NO in step S53), next, in step S54, the processor 81 determines whether or not the Y-acceleration average value has changed to smaller than the first threshold V1 from the first threshold V1 or greater. As a result of the determination, if the Y-acceleration average value has changed to smaller than the first threshold V1 (YES in step S54), the processor 81 proceeds to step S55. If the Y-acceleration average value has not changed to smaller than the first threshold V1 (NO in step S54), the processor 81 proceeds to step S56 described later.

On the other hand, as a result of the determination in step S52, if the predetermined period has not elapsed (NO in step S52), the processor 81 skips the processing in steps S53 to S54 and proceeds to step S56 described later.

Next, in step S56, the processor 81 determines whether or not a shot mode shift operation has been performed, based on the operation data 312. As a result of the determination, if a shot mode shift operation has been performed (YES in step S56), in steps S57 to S59, the processor 81 performs the same processing as in steps S37 to S39 in FIG. 32. On the other hand, if a shot mode shift operation has not been performed (NO in step S56), the processor 81 skips the processing in step S57 to S59 and ends the moving state process.

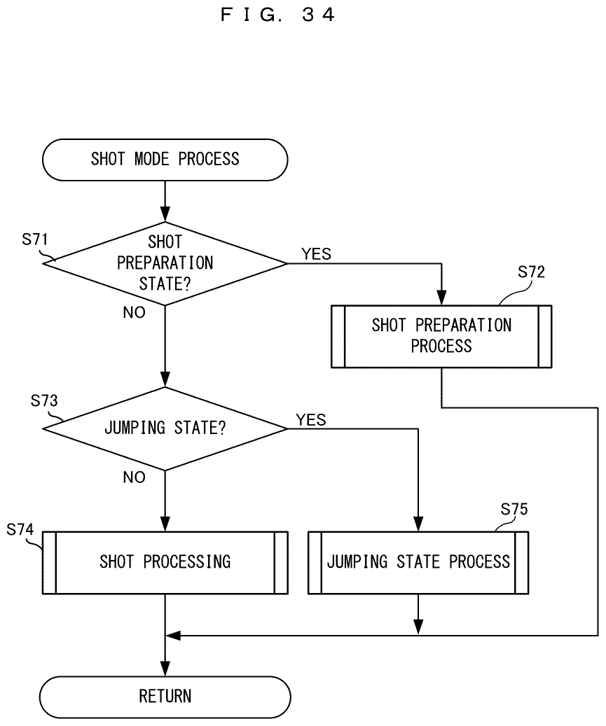

Returning to FIG. 30, next, processing in a case where the present mode is determined to be the shot mode as a result of the determination in step S3 (YES in step S3) will be described. In this case, in step S4, the processor 81 executes a shot mode process. FIG. 34 is a flowchart showing the details of the shot mode process. In FIG. 34, first, in step S71, the processor 81 determines whether or not the PC state is a shot preparation state, based on the preparation state flag 307. As a result of the determination, if the present state is a shot preparation state (YES in step S71), in step S72, the processor 81 executes a shot preparation process.

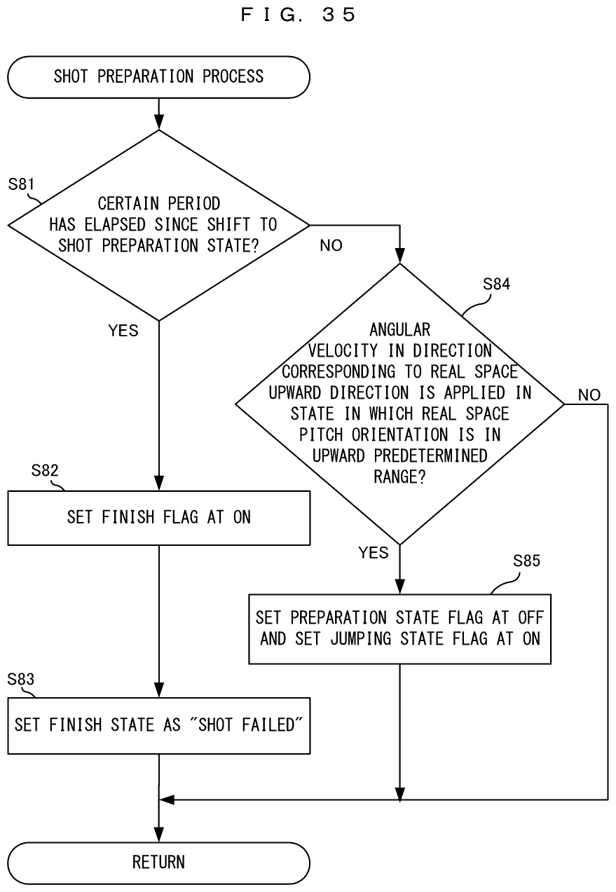

FIG. 35 is a flowchart showing the details of the shot preparation process. In FIG. 35, first, in step S81, the processor 81 determines whether or not a predetermined period has elapsed since the preparation state flag 307 was set at ON, i.e., since the present state was shifted to the shot preparation state. As a result of the determination, if the predetermined period has elapsed (YES in step S81), processing for finishing one set of play as a shot has failed is performed. First, in step S82, the processor 81 sets the finish flag 318 at ON. Next, in step S83, the processor 81 sets the finish state data 319 as “shot failed”. Then, the processor 81 ends the shot preparation process.

On the other hand, as a result of the determination in step S81, if the predetermined period has not elapsed since the present state was shifted to the shot preparation state (NO in step S81), in step S84, the processor 81 determines whether or not an angular velocity having a predetermined value or greater is applied in a direction corresponding to the real space upward direction in a state in which the real space pitch orientation (pitch angle) of the right controller 4 is in an upward predetermined range. For example, after the ZR button 61 is pressed, if a swing-up operation has been performed from a state in which the distal end side of the right controller 4 is directed slightly upward, it is determined that the above determination condition is satisfied. On the other hand, for example, after the ZR button 61 is pressed, if the right controller 4 is swung up so that the distal end side thereof is directed frontward from a state in which the distal end side is directed exactly downward, it is not determined that the above determination condition is satisfied.

As a result of the determination, if the above determination condition is satisfied (YES in step S84), in step S85, the processor 81 sets the preparation state flag 307 at OFF and sets the jumping state flag 308 at ON. On the other hand, if the above determination condition is not satisfied (NO in step S84), the processor 81 skips the processing in step S85. Then, the processor 81 ends the shot preparation process.

Returning to FIG. 34, as a result of the determination in step S71, if the present state is not a shot preparation state (NO in step S71), in step S73, the processor 81 determines whether or not the PC state is a jumping state, based on the jumping state flag 308. As a result of the determination, if the PC state is a jumping state (YES in step S73), in step S75, the processor 81 executes a jumping state process.

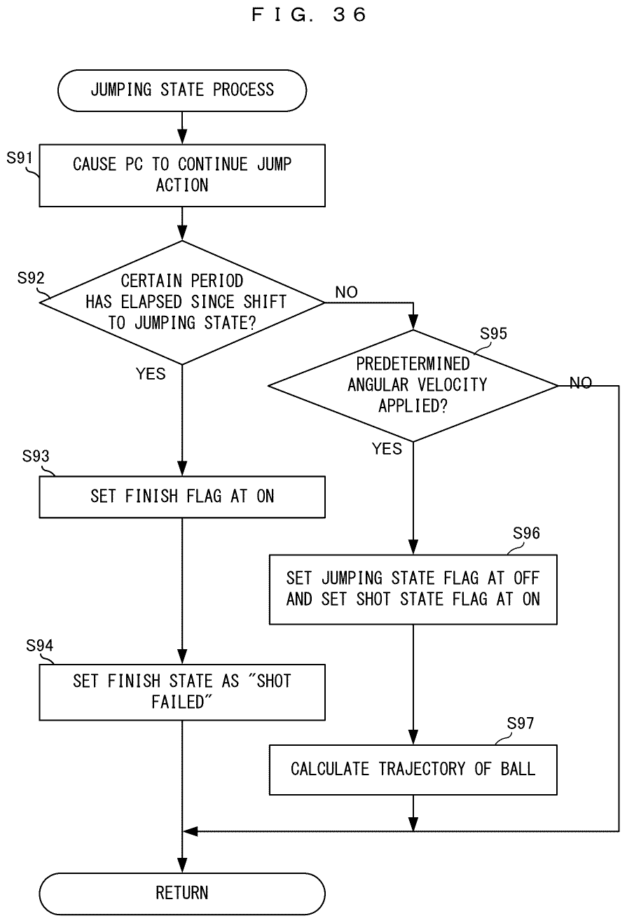

FIG. 36 is a flowchart showing the details of the jumping state process. In FIG. 36, first, in step S91, the processor 81 causes the PC 201 to do a jump action. Next, in step S92, the processor 81 determines whether or not a certain period has elapsed since the PC state was shifted to a jumping state. The certain period is a period from when a jump action of the PC 201 (reproduction of an animation thereof) is started to when the jump action is finished, for example. As a result of the determination, if the certain period has not elapsed (NO in step S92), in step S95, the processor 81 determines whether or not a predetermined angular velocity, e.g., a downward angular velocity, is applied. That is, the processor 81 determines whether or not the swing-down operation has been performed. As a result of the determination, if the swing-down operation has been performed (YES in step S95), in step S96, the processor 81 sets the jumping state flag 308 at OFF and sets the shot state flag 309 at ON. Next, in step S97, the processor 81 calculates a trajectory of the ball. In the exemplary embodiment, as described above, a trajectory of the ball is calculated based on an orientation, a swing velocity, and the like regarding the pitch of the controller in the swing-down operation. Then, the processor 81 ends the jumping state process.

On the other hand, as a result of the determination in step S95, if a swing-down operation has not been performed (NO in step S95), the processor 81 skips the processing in steps S96 and S97 and ends the jumping state process.

Next, processing in a case where the certain period has elapsed since the PC state was shifted to a jumping state as a result of the determination in step S92 (YES in step S92) will be described. This case corresponds to a case where the jump action is finished without making a shot after the PC state is shifted to the jumping state. Therefore, processing for finishing one set of play as a shot has failed is performed. Specifically, in step S93, the processor 81 sets the finish flag 318 at ON. Next, in step S94, the processor 81 sets the finish state data 319 as “shot failed”. Then, the processor 81 ends the jumping state process.

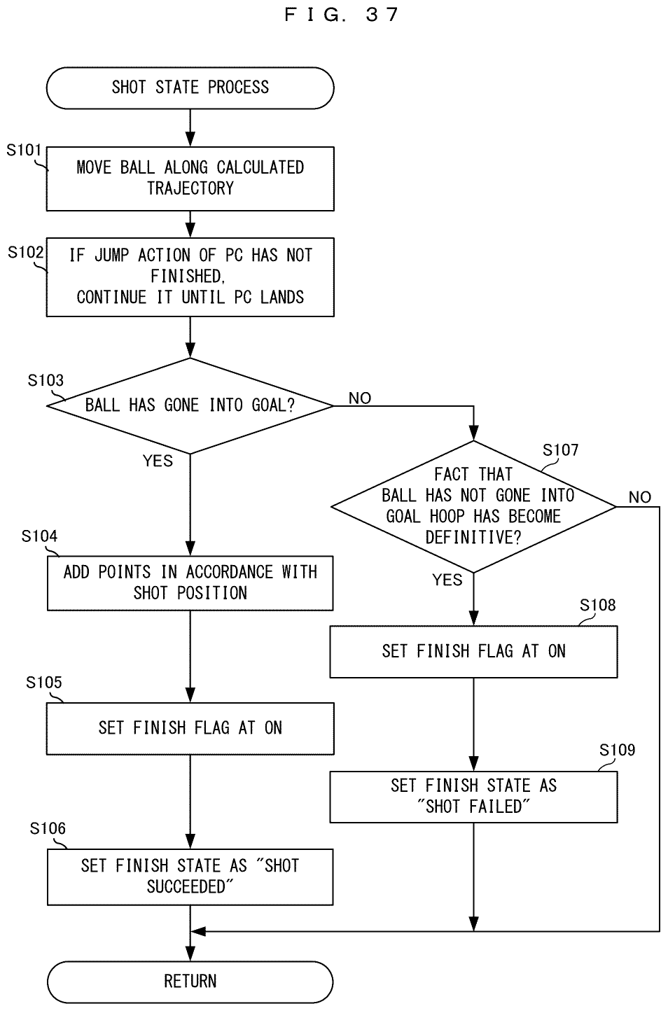

Returning to FIG. 34, next, as a result of the determination in step S73, if the jumping state flag 308 is OFF (NO in step S73), in step S74, the processor 81 executes a shot process. FIG. 37 is a flowchart showing the details of the shot process. In FIG. 37, first, in step S101, the processor 81 moves the ball 204 along the calculated trajectory of the ball. Next, in step S102, the processor 81 continues the jump action of the PC 201 which has been continuing also after a shot was made. This processing is executed until the PC 201 who has made a shot lands.

Next, in step S103, the processor 81 determines whether or not the ball 204 has gone into the goal hoop. As a result of the determination, if the ball 204 has gone into the goal hoop (YES in step S103), in step S104, the processor 81 adds points according to the shot position information 321, to the user-side team. Next, in step S105, the processor 81 sets the finish flag 318 at ON. Subsequently, in step S106, the processor 81 sets the finish state data 319 as “shot succeeded”. Then, the processor 81 ends the shooting state process.

On the other hand, as a result of the determination in step S103, if the ball 204 has not gone into the goal hoop (NO in step S103), in step S107, the processor 81 determines whether or not a fact that the ball 204 has not gone into the goal hoop, i.e., a shot has failed, has become definitive. For example, if the ball 204 has landed without passing through the goal hoop, it is determined that a shot has failed. As a result of the determination, if a fact that a shot has failed has become definitive (YES in step S107), in step S108, the processor 81 sets the finish flag 318 at ON. Subsequently, in step S109, the processor 81 sets the finish state data 319 as “shot failed”. Then, the processor 81 ends the shooting state process. On the other hand, if failure of a shot has not become definitive (NO in step S107), the processor 81 skips the processing in steps S108 and S109 and ends the shooting state process.

Returning to FIG. 34, when the shot preparation process, the jumping state process, or the shot process ends, the shot mode process ends.

Returning to FIG. 30, subsequent to the moving state process, the stopped state process, or the shot mode process, in step S8, the processor 81 generates and outputs a game image in which the result of the above various game processes is reflected.

Next, in step S9, the processor 81 determines whether or not the finish flag 318 is ON. If the finish flag 318 is not ON (NO in step S9), the processor 81 returns to step S1, to repeat the process. On the other hand, if the finish flag 318 is ON (YES in step S9), in step S10, the processor 81 displays a representation for a case where a shot has succeeded or a shot has failed, based on the finish state data 319. Thus, the game processing (for one set) is finished.

As described above, in the exemplary embodiment, an operation of moving the controller is determined while the correspondence relationship between the direction in the real space and the direction with respect to the controller is updated in accordance with the orientation (the way of holding) around the front axis of the controller. Therefore, movement of the controller in the predetermined direction in the real space can be recognized irrespective of the orientation of the controller. Thus, for example, it is possible to provide a game in which an operation of moving the controller is used while the way of holding the controller is inhibited from influencing recognition of the orientation regarding the pitch in the real space.

### Modifications

In the above exemplary embodiment, the case where, in the moving state, a route to a target position is automatically calculated and the PC 201 is automatically moved along the route, has been shown. In this regard, in another exemplary embodiment, in the moving state, the movement direction of the PC 201 on the field may be determined based on the orientation of the controller regarding the yaw direction in the real space. Also in this case, the orientation of the controller regarding the yaw direction in the real space may be identified based on the correspondence relationship between the direction with respect to the controller and the direction in the real space. Thus, in the moving state, for example, it becomes possible to manually control the movement direction of the PC 201 by changing the direction of the distal end side of the controller to the left-right direction in the real space during a vertical swing operation. In addition, for example, it is possible to move the PC 201 in a direction desired by a user, by starting a vertical swing operation after directing the controller to a direction in which the user desires to move the PC 201, in a stopped state.

In the above exemplary embodiment, the case where the ball sport game is basketball has been shown. However, without limitation thereto, the above game processing is applicable to a ball sport game that involves movement corresponding to dribbling or a goal as a target to which a ball is shot, e.g., a soccer game.

In the above exemplary embodiment, the case where the “way of holding” is classified into three kinds has been shown. However, without limitation to three kinds, classification of the way of holding may be more divided. Then, the correspondence relationship between the direction in the controller coordinate system and the direction in the real space coordinate system may be updated in accordance with each way of holding.

In the above exemplary embodiment, the case where the game processing is executed by a single main body apparatus 2 has been described. The main body apparatus 2 may include a plurality of storages and processors. Then, the game processing may be executed in a shared manner by the storages and the processors. The above game processing may be executed in a distributed system composed of a plurality of information processing apparatuses including a server.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A computer-readable non-transitory storage medium having stored therein a game program configured to cause a computer of an information processing apparatus to execute a ball sport game in which, based on operation data including at least acceleration data and angular velocity data and transmitted from an operation device including an acceleration sensor and an angular velocity sensor, the computer executes:
setting and updating a correspondence relationship between a direction in a space and a direction with respect to the operation device, in accordance with an orientation around a predetermined axis of the operation device;
identifying an orientation of the operation device regarding a pitch in the space;
in a case where a first condition for at least one of the acceleration data and the angular velocity data in at least an up-down direction in the space is satisfied, causing a player character having a ball to do an action of moving on a field in a game space; and
in a case where a second condition for an orientation regarding the pitch in the space and at least one of the acceleration data and the angular velocity data is satisfied, causing the player character having the ball to do a shot action of shooting the ball.

2. The computer-readable non-transitory storage medium having stored therein the game program according to claim 1, wherein
the operation device has a shape elongated in a longitudinal direction,
the predetermined axis is an axis along the longitudinal direction of the operation device, and
the orientation regarding the pitch in the space is a pitch of a direction vector of the predetermined axis in the space.

3. The computer-readable non-transitory storage medium having stored therein the game program according to claim 2, wherein
the operation device has a button surface at which an operation button is provided, and
based on the operation data, the computer further executes:
identifying at least in which state the button surface is among an upward state, a rightward state, and a leftward state, and setting and updating the correspondence relationship between the direction in the space and the direction of the operation device, based on the identified state.

4. The computer-readable non-transitory storage medium having stored therein the game program according to claim 2, wherein
the computer further executes:
in a case where the pitch of the direction vector of the predetermined axis in the space is in an upward first range, refraining from updating the correspondence relationship between the direction in the space and the direction of the operation device in accordance with the orientation around the predetermined axis of the operation device.

5. The computer-readable non-transitory storage medium having stored therein the game program according to claim 1, wherein
the first condition includes at least that a magnitude of an acceleration applied in the up-down direction in the space exceeds a first threshold.

6. The computer-readable non-transitory storage medium having stored therein the game program according to claim 5, wherein
the computer further executes:
in a case where the magnitude of the acceleration applied in the up-down direction in the space exceeds the first threshold and then becomes smaller than the first threshold, or in a case where the magnitude of the acceleration exceeds a second threshold greater than the first threshold and then becomes smaller than the second threshold, stopping the action in which the player character having the ball moves on the field.

7. The computer-readable non-transitory storage medium having stored therein the game program according to claim 5, wherein
the ball sport game is a basketball game, and
the action of moving on the field is a dribbling action involving movement of the player character.

8. The computer-readable non-transitory storage medium having stored therein the game program according to claim 1, wherein
the ball sport game is a basketball game, and
the computer further executes:
in a case where the orientation regarding the pitch in the space is in an upward predetermined range and an upward predetermined angular velocity in the space is applied to the operation device, causing the player character having the ball to start a jump action; and
causing the player character having the ball to do the shot action, on the second condition that a predetermined angular velocity is applied to the operation device while the player character having the ball is doing the jump action.

9. The computer-readable non-transitory storage medium having stored therein the game program according to claim 8, wherein
the computer further executes:
in a case where the shot action has been done, determining a trajectory of the ball corresponding to the shot action, based on at least the orientation regarding the pitch in the space.

10. The computer-readable non-transitory storage medium having stored therein the game program according to claim 1, wherein
the computer further executes:
identifying an orientation of the operation device regarding a yaw in the space; and
in a case where the first condition is satisfied, causing the player character having the ball to do an action of moving in a direction according to the orientation regarding the yaw in the space, on the field in the game space.

11. A game processing method configured to cause a computer of an information processing apparatus to execute a ball sport game in which, based on operation data including at least acceleration data and angular velocity data and transmitted from an operation device including an acceleration sensor and an angular velocity sensor, the computer executes:
setting and updating a correspondence relationship between a direction in a space and a direction with respect to the operation device, in accordance with an orientation around a predetermined axis of the operation device;
identifying an orientation of the operation device regarding a pitch in the space;
in a case where a first condition for at least one of the acceleration data and the angular velocity data in at least an up-down direction in the space is satisfied, causing a player character having a ball to do an action of moving on a field in a game space; and
in a case where a second condition for an orientation regarding the pitch in the space and at least one of the acceleration data and the angular velocity data is satisfied, causing the player character having the ball to do a shot action of shooting the ball.

12. The game processing method according to claim 11, wherein
the operation device has a shape elongated in a longitudinal direction,
the predetermined axis is an axis along the longitudinal direction of the operation device, and
the orientation regarding the pitch in the space is a pitch of a direction vector of the predetermined axis in the space.

13. The game processing method according to claim 12, wherein
the operation device has a button surface at which an operation button is provided, and
based on the operation data, the computer further executes:
identifying at least in which state the button surface is among an upward state, a rightward state, and a leftward state, and setting and updating the correspondence relationship between the direction in the space and the direction of the operation device, based on the identified state.

14. The game processing method according to claim 12, wherein
the computer further executes:
in a case where the pitch of the direction vector of the predetermined axis in the space is in an upward first range, refraining from updating the correspondence relationship between the direction in the space and the direction of the operation device in accordance with the orientation around the predetermined axis of the operation device.

15. The game processing method according to claim 11, wherein
the first condition includes at least that a magnitude of an acceleration applied in the up-down direction in the space exceeds a first threshold.

16. The game processing method according to claim 15, wherein
the computer further executes:
in a case where the magnitude of the acceleration applied in the up-down direction in the space exceeds the first threshold and then becomes smaller than the first threshold, or in a case where the magnitude of the acceleration exceeds a second threshold greater than the first threshold and then becomes smaller than the second threshold, stopping the action in which the player character having the ball moves on the field.

17. The game processing method according to claim 15, wherein
the ball sport game is a basketball game, and
the action of moving on the field is a dribbling action involving movement of the player character.

18. The game processing method according to claim 11, wherein
the ball sport game is a basketball game, and
the computer further executes:
in a case where the orientation regarding the pitch in the space is in an upward predetermined range and an upward predetermined angular velocity in the space is applied to the operation device, causing the player character having the ball to start a jump action; and
causing the player character having the ball to do the shot action, on the second condition that a predetermined angular velocity is applied to the operation device while the player character having the ball is doing the jump action.

19. The game processing method according to claim 18, wherein
the computer further executes:
in a case where the shot action has been done, determining a trajectory of the ball corresponding to the shot action, based on at least the orientation regarding the pitch in the space.

20. The game processing method according to claim 11, wherein
the computer further executes:
identifying an orientation of the operation device regarding a yaw in the space; and
in a case where the first condition is satisfied, causing the player character having the ball to do an action of moving in a direction according to the orientation regarding the yaw in the space, on the field in the game space.

21. A game system including a computer configured to execute a ball sport game in which, based on operation data including at least acceleration data and angular velocity data and transmitted from an operation device including an acceleration sensor and an angular velocity sensor, the computer executes:
setting and updating a correspondence relationship between a direction in a space and a direction with respect to the operation device, in accordance with an orientation around a predetermined axis of the operation device;
identifying an orientation of the operation device regarding a pitch in the space;
in a case where a first condition for at least one of the acceleration data and the angular velocity data in at least an up-down direction in the space is satisfied, causing a player character having a ball to do an action of moving on a field in a game space; and
in a case where a second condition for an orientation regarding the pitch in the space and at least one of the acceleration data and the angular velocity data is satisfied, causing the player character having the ball to do a shot action of shooting the ball.

22. The game system according to claim 21, wherein
the operation device has a shape elongated in a longitudinal direction,
the predetermined axis is an axis along the longitudinal direction of the operation device, and
the orientation regarding the pitch in the space is a pitch of a direction vector of the predetermined axis in the space.

23. The game system according to claim 22, wherein
the operation device has a button surface at which an operation button is provided, and
based on the operation data, the computer further executes:
identifying at least in which state the button surface is among an upward state, a rightward state, and a leftward state, and setting and updating the correspondence relationship between the direction in the space and the direction of the operation device, based on the identified state.

24. The game system according to claim 22, wherein
the computer further executes:
in a case where the pitch of the direction vector of the predetermined axis in the space is in an upward first range, refraining from updating the correspondence relationship between the direction in the space and the direction of the operation device in accordance with the orientation around the predetermined axis of the operation device.
